(19) United States
(12) Patent Application Publication
(10) Pub. No.: US 2021/0112228 A1
(43) Pub. Date: Apr. 15, 2021

(54) IMAGE DATA GENERATION DEVICE, IMAGE REPRODUCING DEVICE, IMAGE DATA GENERATION METHOD, CONTROL PROGRAM, AND RECORDING MEDIUM

(71) Applicant: SHARP KABUSHIKI KAISHA, Sakai City, Osaka (JP)

(72) Inventors: TOMOYUKI YAMAMOTO, Sakai City, Osaka (JP); KYOHEI IKEDA, Sakai City, Osaka (JP)

(21) Appl. No.: 16/500,086

(22) PCT Filed: Mar. 29, 2018
(86) PCT No.: PCT/JP2018/013466

§ 371 Date: Oct. 1, 2019

(30) Foreign Application Priority Data
Apr. 5, 2017 (JP) 2017-075361

(51) Int. Cl. H04N 13/111; H04N 13/122; H04N 13/161

(52) U.S. Cl. CPC H04N 13/111; H04N 13/161; H04N 13/122

(57) ABSTRACT

An image data device includes an intermediate viewpoint image data generation unit configured to refer to at least one of multiple input image data for representing images from multiple viewpoints different from each other and generate intermediate viewpoint image data for indicating images corresponding to the viewpoints included in multiple intermediate viewpoints regularly arranged in at least one dimension direction in a straight line or curved line coordinate system of one or more dimensions.

### TECHNICAL FIELD

The present invention relates mainly to an image data generation device that generates image data by which an image from a target viewpoint can be reproduced.

### BACKGROUND ART

An example of a technique that can represent a 360 degree field of view with an image includes a 360 video (full spherical image) and an extended 360 video. (a) of FIG. 19 is a diagram schematically illustrating the 360 video, and (b) of FIG. 19 is a diagram schematically illustrating the extended 360 video.

The 360 Video (3 Degree of Freedom (3DoF)) is an image that can be viewed looking around the periphery from one viewpoint, and more specifically, is an image capable of observing an entire circumference (4π steradians) from one point in a virtual space. The 360 video based on an actually captured image is an image captured by a camera capable of capturing a full circumference or is generated by stitching respective images captured by multiple cameras.

The extended 360 video is a 360 video that can be viewed while moving the viewpoint position, and more particularly, is a video capable of observing an entire circumference from within a predetermined range based on one point in a virtual space. In this technique, a slight viewpoint movement of a viewer can be supported to improve the reality in a case of viewing with a head-mounted display (HMD). By supporting a wide range of viewpoint movement of the viewer, recorded scenes can be observed from various directions. The extended 360 video is also referred to as 3DoF+ or 6DoF depending on the wideness of the possible range of viewpoint movement. 3DoF+ is capable of viewpoint movement within a narrower range and 6DoF is capable of viewpoint movement within a wider range.

As a technique for viewing an image in which viewpoint position moves similar to the extended 360 video, PTL 1 discloses a technique in which multiple camera images are synthesized to generate a virtual viewpoint image. In this document, a means for generating an image of a predetermined virtual viewpoint position based on multiple camera images and information of camera positions is disclosed. In this technique, an image is generated by transparent transformation of camera images, based on virtual viewpoint positions and camera positions.

### CITATION LIST

### Patent Literature

PTL 1: IP 2013-106324 A (published on May 30, 2013)

### SUMMARY OF INVENTION

### Technical Problem

The generation of the extended 360 video described above needs to obtain an image (target viewpoint image) with a target viewpoint as a viewpoint of the image, through synthesis using multiple camera images. In a case that a target viewpoint image is created directly from camera images at the time of reproducing the target viewpoint image, there is a problem in that the reproducing process is complex. For example, in some circumstances, the synthesis for one target viewpoint image requires searching (position confirmation) or decoding processing of the images from all the provided cameras. In such a problem, simplification of the reproducing process is important to meet the real time and low delay requirements in the generation process of the target viewpoint image.

In light of the foregoing problem, an object of the present invention is to provide a technique capable of simplifying a reproducing process of an image from a target viewpoint.

### Solution to Problem

In order to solve the above-described problem, an image data generation device according to an aspect of the present invention is an image data generation device for generating image data, the image data generation device including: an input image data acquisition unit configured to acquire multiple input image data for representing images from multiple viewpoints different from each other; and an intermediate viewpoint image data generation unit configured to refer to at least one of the multiple input image data and generate intermediate viewpoint image data for indicating images corresponding to the viewpoints included in multiple intermediate viewpoints regularly arranged in at least one dimension direction for a straight line or curved line coordinate system of one or more dimensions.

In order to solve the above-described problem, an image data generation device according to an aspect of the present invention is an image data generation device for generating image data for indicating an image from a target viewpoint, the image data generation device including: an intermediate viewpoint image data acquisition unit configured to acquire intermediate viewpoint image data for indicating images corresponding to the viewpoints included in multiple intermediate viewpoints regularly arranged in at least one dimension direction for a straight line or curved line coordinate system of one or more dimensions; and a target viewpoint image data generation unit configured to refer to the intermediate viewpoint image data acquired by the intermediate viewpoint image data acquisition unit, and generate target viewpoint image data for indicating an image from the target viewpoint.

In order to solve the above-described problem, an image data generation method according to an aspect of the present invention is an image data generation method by an image data generation device for generating image data generation method image data, the image data generation method including the steps of: acquiring multiple input image data representing images from multiple viewpoints different from each other; and referring to at least one of the multiple input image data and generating intermediate viewpoint image data for indicating images corresponding to the viewpoints included in multiple intermediate viewpoints regularly arranged in at least one dimension direction for a straight line or curved line coordinate system of one or more dimensions.

In order to solve the above-described problem, an image data generation method according to an aspect of the present invention is an image data generation method by an image data generation device for generating image data indicating an image from a target viewpoint, the image data generation method including the steps of: acquiring intermediate viewpoint image data for indicating images corresponding to the viewpoints included in multiple intermediate viewpoints regularly arranged in at least one dimension direction for a straight line or curved line coordinate system of one or more dimensions; and referring to the intermediate viewpoint image data acquired in the step of acquiring intermediate viewpoint image data and generating target viewpoint image data for indicating an image from the target viewpoint.

### Advantageous Effects of Invention

According to an aspect of the present invention, a reproducing process of an image from a target viewpoint can be simplified.

### BRIEF DESCRIPTION OF DRAWINGS

FIG. 1 is a block diagram illustrating a configuration of an extended 360 video data recording and reproducing system according to Embodiment 1 of the present invention.

FIG. 2 is a flowchart illustrating an example of an intermediate video set generation method by an extended 360 video data recording device according to Embodiment 1 of the present invention.

FIG. 3 is a flowchart illustrating an example of a target viewpoint image generation method by an extended 360 video data reproducing device according to Embodiment 1 of the present invention.

FIG. 4 is a diagram for schematically illustrating an intermediate 360 video set generation method and a target viewpoint image generation method according to an embodiment of the present invention.

FIG. 5 is a diagram for illustrating intermediate viewpoint definition according to an embodiment of the present invention.

FIGS. 6(a) to 6(c) are diagrams, each illustrating an example of lattice points in which intermediate viewpoints are arranged according to an embodiment of the present invention.

FIG. 7 is a diagram illustrating an example of lattice points in three-dimensional coordinates at which intermediate viewpoints are arranged according to an embodiment of the present invention.

FIGS. 8(a) to 8(c) are diagrams, each illustrating an example other than lattice points at which intermediate viewpoints are arranged according to an embodiment of the present invention.

FIG. 9 is a diagram for illustrating the arrangement of intermediate viewpoints depending on depth of an imaging target according to an embodiment of the present invention.

FIG. 10 is a diagram illustrating an example of arrangement of intermediate viewpoints configured by an intermediate viewpoint configuration unit according to an embodiment of the present invention.

FIG. 11 is a diagram for illustrating an intermediate 360 video set generation process according to an embodiment of the present invention.

FIG. 12 is a diagram for illustrating a format of extended 360 video data according to an embodiment of the present invention.

FIG. 13 is a diagram for illustrating a viewpoint image generation process according to an embodiment of the present invention.

FIG. 14 is a block diagram illustrating a configuration of an extended 360 video data recording and reproducing system according to Embodiment 2 of the present invention.

FIG. 15 is a flowchart illustrating an example of an intermediate video set generation method by an extended 360 video data recording device according to Embodiment 2 of the present invention.

FIG. 16 is a flowchart illustrating an example of a target viewpoint image generation method by an extended 360 video data reproducing device according to Embodiment 2 of the present invention.

FIG. 17(a) is a block diagram illustrating a configuration of an extended 360 video data recording and reproducing system according to Embodiment 3 of the present invention. FIG. 17(h) is a block diagram illustrating a configuration of an extended 360 video data reproducing unit according to Embodiment 3 of the present invention.

FIG. 18 is a flowchart illustrating an example of a target viewpoint image generation method by an extended 360 video data reproducing device according to Embodiment 3 of the present invention.

FIG. 19(a) is a diagram schematically illustrating a 360 video in related art, and FIG. 19(b) is a diagram schematically illustrating an extended 360 video in related art.

### DESCRIPTION OF EMBODIMENTS

Embodiments of the present invention will be described below in detail. It should be noted that each constitution described in the present embodiments is not intended to exclusively limit the scope of the present invention thereto as long as there is no specific description in particular, and is merely an example for description.

Each embodiment of the present invention addresses an issue of how information needed to reproduce image around a particular observation position can be described in a compact and practical representation. To achieve this, multiple virtual 360 cameras are arranged in an observation position, and data (intermediate viewpoint image data) that can be captured by the cameras is created, and image data (target viewpoint image data) with viewpoints from any position near the observation position is generated using the data.

### Embodiment 1

### Extended 360 Video Data Recording and Reproducing System

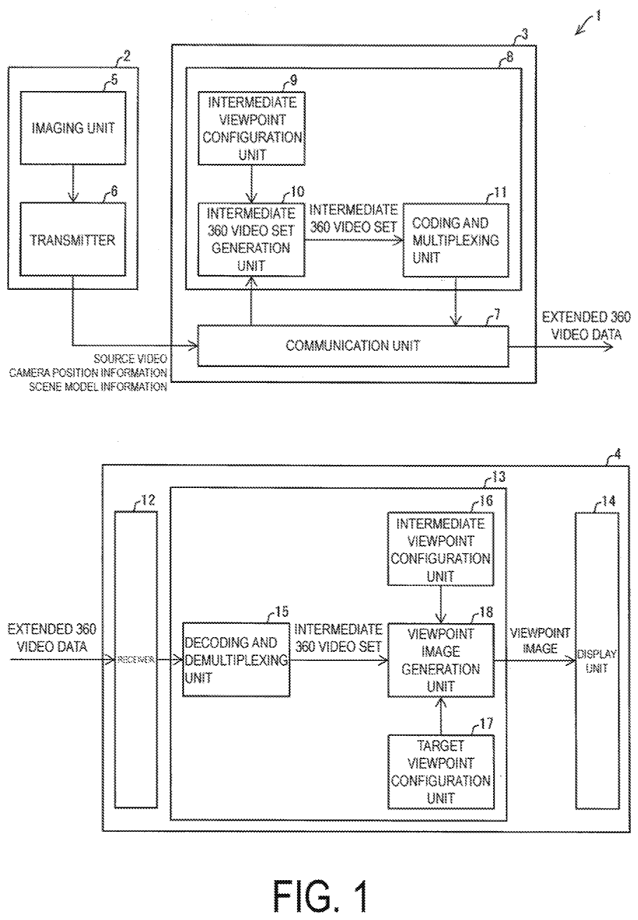

An extended 360 video data recording and reproducing system 1 according to the present embodiment will be described in detail with reference to FIG. 1. FIG. 1 is a block diagram illustrating a configuration of the extended 360 video data recording and reproducing system 1 according to the present embodiment. As illustrated in FIG. 1, the extended 360 video data recording and reproducing system 1 includes an imaging apparatus 2, an extended 360 video data recording device 3 (corresponding to the image data generation device in the claims), and an extended 360 video data reproducing device 4 (corresponding to the image reproducing device in the claims). Note that, in the following, each member included in the extended 360 video data recording and reproducing system 1 will be described, but details will be described below by providing a section for each member.

The imaging apparatus 2 includes an imaging unit 5 and a transmitter 6. Note that in FIG. 1, only one imaging unit 5 is illustrated, but the extended 360 video data recording and reproducing system 1 includes multiple imaging apparatuses (not illustrated) having a similar configuration to that of the imaging apparatus 2.

The imaging unit 5 acquires image data by capturing the imaging target. Each of the multiple imaging units provided with the multiple imaging apparatuses described above having a similar configuration to that of the imaging unit 5 acquires image data with different viewpoints from each other.

The transmitter 6 transmits image data acquired by the imaging unit 5 and the like to the extended 360 video data recording device 3. The transmitter 6 transmits image data with different viewpoints from each other acquired by each of the multiple imaging units described above, to the extended 360 video data recording device 3.

### Extended 360 Video Data Recording Device 3

As illustrated in FIG. 1, the extended 360 video data recording device 3 includes a communication unit 7 (corresponding to the input image data acquisition unit in the claims), and a processing unit 8.

The communication unit 7 receives image data (corresponding to the input image data in the claims) transmitted by the transmitter 6 of the imaging apparatus 2.

The processing unit 8 includes an intermediate viewpoint configuration unit 9, an intermediate 360 video set generation unit 10 (corresponding to the intermediate viewpoint image data generation unit in the claims), and a coding and multiplexing unit 11 (corresponding to the multiplexing unit in the claims). To describe a schematic function of the processing unit 8, the processing unit 8 refers to at least one of multiple image data received by the communication unit 7, and generates intermediate viewpoint image data indicating images corresponding to the viewpoints from each of multiple intermediate viewpoints regularly arranged in at least one dimension direction for a straight line or curved line coordinate system of one or more dimensions. Note that details of the intermediate viewpoints will be described later.

The intermediate viewpoint configuration unit 9 configures multiple intermediate viewpoints regularly arranged in at least one dimension direction for a straight line or curved line coordinate system of one or more dimensions.

The intermediate 360 video set generation unit 10 refers to at least one of the multiple image data received by the communication unit 7, and generates intermediate viewpoint image data indicating images corresponding to the viewpoints included in the multiple intermediate viewpoints arranged based on the configuration of the intermediate viewpoint configuration unit 9.

The coding and multiplexing unit 11 codes intermediate viewpoint image data (intermediate 360 video set) generated by the intermediate 360 video set generation unit 10 and multiplexes coded data.

The communication unit 7 transmits intermediate viewpoint image data (extended 360 video data) multiplexed by the coding and multiplexing unit 11 to the extended 360 video data reproducing device 4.

### Extended 360 Video Data Reproducing Device 4

As illustrated in FIG. 1, the extended 360 video data reproducing device 4 includes a receiver 12 (corresponding to the intermediate viewpoint image data acquisition unit in the claims), a processing unit 13, and a display unit 14.

The receiver 12 receives the intermediate viewpoint image data (extended 360 video data) transmitted by the communication unit 7 of the extended 360 video data recording device 3.

The processing unit 13 includes a decoding and demultiplexing unit 15, an intermediate viewpoint configuration unit 16, a target viewpoint configuration unit 17, and a viewpoint image generation unit 18 (corresponding to the target viewpoint image data generation unit in the claims). To describe a schematic function of the processing unit 13, the processing unit 13 generates target viewpoint image data indicating an image from the target viewpoint with reference to the intermediate viewpoint image data received by the receiver 12.

The decoding and demultiplexing unit 15 decodes the intermediate viewpoint image data (extended 360 video data) received by the receiver 12, and demultiplexer the decoded data.

The intermediate viewpoint configuration unit 16 configures multiple intermediate viewpoints regularly arranged in at least one dimension direction for a straight line or curved line coordinate system of one or more dimensions. Note that the intermediate viewpoints configured by the intermediate viewpoint configuration unit 16 needs to be the same as or at least a subset of the intermediate viewpoints configured by the intermediate viewpoint configuration unit 9 in the extended 360 video data recording device. While information of the intermediate viewpoints configured in the present embodiment is assumed to be shared in advance, information of the intermediate viewpoints in another embodiment may be included and notified in the extended 360 video data.

The target viewpoint configuration unit 17 configures a target viewpoint. Note that the target viewpoint configured by the target viewpoint configuration unit 17 herein may be a target viewpoint configured automatically by the target viewpoint configuration unit 17, or may be a target viewpoint based on a user input.

With reference to the intermediate viewpoint image data (intermediate 360 video set) demultiplexed by the decoding and demultiplexing unit 15, and the arrangement of the intermediate viewpoints configured by the intermediate viewpoint configuration unit 16, the viewpoint image generation unit 18 generates target viewpoint image data indicating an image from the target viewpoint configured by the target viewpoint configuration unit 17.

The display unit 14 displays the image indicated by the target viewpoint image data generated by the viewpoint image generation unit 18, Examples of the display unit 14 include a head-mounted display.

### Intermediate 360 Video Set Generation Method and Target Viewpoint Image Generation Method

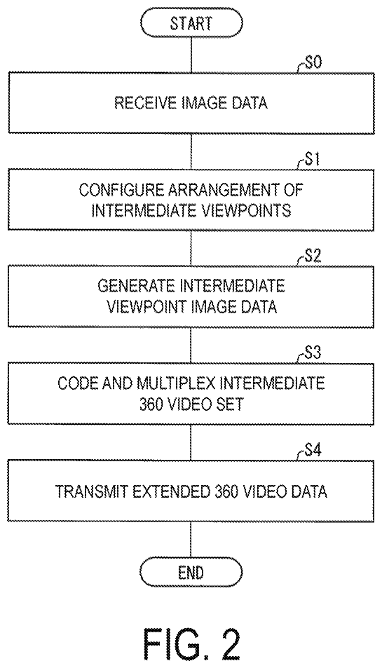

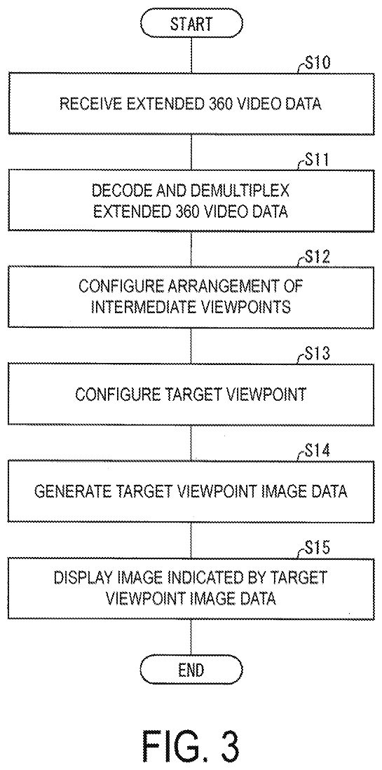

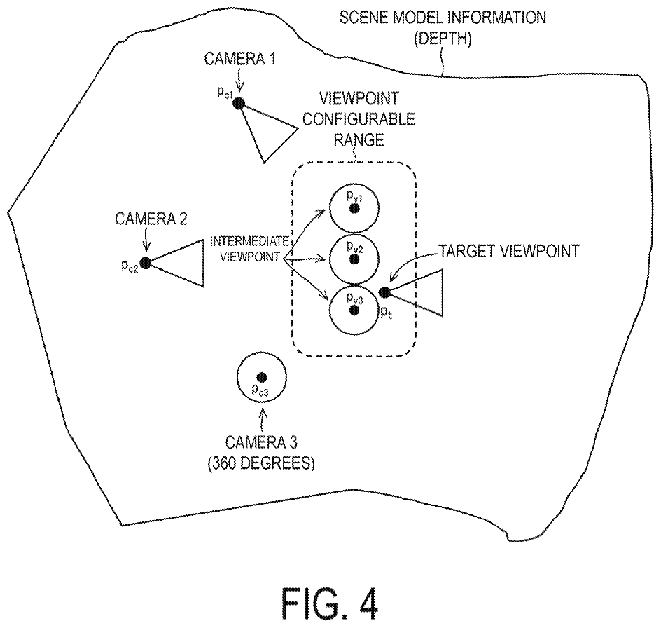

An intermediate 360 video set generation method by the extended 360 video data recording device 3 according to the present embodiment and a target viewpoint image generation method by the extended 360 video data reproducing device 4 according to the present embodiment will be described with reference to FIG. 2 to FIG. 4. FIG. 2 is a flowchart illustrating an example of the intermediate video set generation method by the extended 360 video data recording device 3 according to the present embodiment. FIG. 3 is a flowchart illustrating an example of the target viewpoint image generation method by the extended 360 video data reproducing device 4 according to the present embodiment. FIG. 4 is a diagram schematically illustrating a camera P_{c1}, a camera P_{c2}, and a camera P_{c3} having a similar configuration to that of the imaging apparatus 2, and an intermediate viewpoint Pᵥ₁, an intermediate viewpoint Pᵥ₂, and an intermediate viewpoint Pᵥ₃, and a target viewpoint Pₜ included in scene model information, which is information approximating a 3D shape of an imaging area.

The intermediate 360 video set generation method and the target viewpoint image generation method according to the present embodiment will be described below with reference to FIG. 4. For example, the extended 360 video data recording device 3 generates intermediate viewpoint image data indicating images corresponding to the viewpoints included in the intermediate viewpoint Pᵥ₁, the intermediate viewpoint Pᵥ₂, and the intermediate viewpoint Pᵥ₃, from the image data captured by each of the camera P_{c1}, the camera P_{c2}, and the camera P_{c3}, illustrated in FIG. 4, respectively. The extended 360 video data reproducing device 4 then refers to at least one of intermediate viewpoint image data generated by the extended 360 video data recording device 3 and generates the target viewpoint image data corresponding to the viewpoint, the target viewpoint Pₜ.

Each step of the intermediate 360 video set generation method will be described below with reference to FIG. 2. Note that details of each of the steps will be described later in the section for each member.

First, the communication unit 7 receives the image data transmitted by the imaging apparatus 2 (step S0).

Next, the intermediate viewpoint configuration unit 9 configures multiple intermediate viewpoints regularly arranged in at least one dimension direction for a straight line or curved line coordinate system of one or more dimensions (step S1),

Next, the intermediate 360 video set generation unit 10 refers to at least one of the multiple image data received by the communication unit 7, and generates intermediate viewpoint image data indicating images corresponding to the viewpoints included in the multiple intermediate viewpoints arranged based on the configuration of the intermediate viewpoint configuration unit 9 (step S2).

Next, the coding and multiplexing unit 11 codes intermediate viewpoint image data (intermediate 360 video set) generated by the intermediate 360 video set generation unit 10 and multiplexes coded data (step S3).

Next, the communication unit 7 transmits intermediate viewpoint image data (extended 360 video data) multiplexed by the coding and multiplexing unit 11 to the extended 360 video data reproducing device 4 (step S4).

Each step of the target viewpoint image generation method will be described below with reference to FIG. 3. Note that details of each of the steps will be described later in the section for each member.

First, the receiver 12 receives the intermediate viewpoint image data (extended 360 video data) transmitted by the communication unit 7 of the extended 360 video data recording device 3 (step S10).

The decoding and demultiplexing unit 15 decodes the intermediate viewpoint image data (extended 360 video data) received by the receiver 12, and demultiplexes the decoded data (step S11).

The intermediate viewpoint configuration unit 16 configures multiple intermediate viewpoints regularly arranged in at least one dimension direction for a straight line or curved line coordinate system of one or more dimensions (step S12),

The target viewpoint configuration unit 17 configures a target viewpoint (step S3).

With reference to the intermediate viewpoint image data (intermediate 360 video set) demultiplexed by the decoding and demultiplexing unit 15, and the arrangement of the intermediate viewpoints configured by the intermediate viewpoint configuration unit 16, the viewpoint image generation unit 18 generates target viewpoint image data indicating an image from the target viewpoint configured by the target viewpoint configuration unit 17 (step S14).

The display unit 14 displays the image indicated by the target viewpoint image data generated by the viewpoint image generation unit 18 (step S15).

### Intermediate Viewpoint Definition

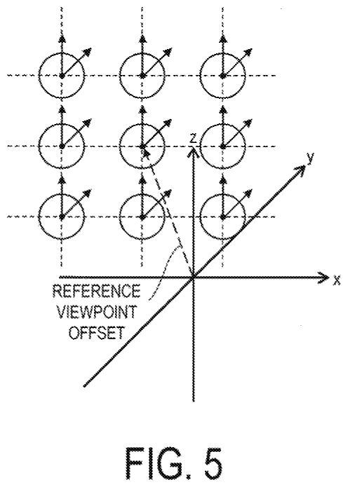

Hereinafter, the definitions of the intermediate viewpoints configured in each of steps S1 and S12 by the intermediate viewpoint configuration unit 9 and the intermediate viewpoint configuration unit 16 are described in detail with reference to FIG. 5, FIG. 5 is a diagram illustrating multiple intermediate viewpoints arranged along the XZ plane in three-dimensional coordinates.

For example, as illustrated in FIG. 5, the intermediate viewpoint configuration unit 9 and the intermediate viewpoint configuration unit 16 arrange the intermediate viewpoints at lattice points on the XZ plane (respective intersection points of the lattice) The intermediate viewpoint configuration unit 9 and the intermediate viewpoint configuration unit 16 configure definition information regarding the intermediate viewpoints illustrated below.

For example, the intermediate viewpoint configuration unit 9 and the intermediate viewpoint configuration unit 16 configure a position and orientation of the lattice within the virtual space as the definition information of the intermediate viewpoints. An example of the definition information of the position of the lattice within the virtual space includes a reference viewpoint offset illustrated in FIG. 5. Examples of the definition information of the orientation of the lattice within the virtual space include a vertical vector and a horizontal vector, which are lattice direction vectors on the plane. That is, a combination of the reference viewpoint offset, the vertical vector, and the horizontal vector can be utilized to determine both the position and orientation of the lattice within the virtual space. A combination with another parameter that define the position and orientation of the lattice within the virtual space may be used. For example, a normal vector of the plane may be used instead of the horizontal vector.

For example, the intermediate viewpoint configuration unit 9 and the intermediate viewpoint configuration unit 16 configure the number of intermediate viewpoints, each intermediate viewpoint position, map information of each intermediate viewpoint and associated data, and the like, as the definition information of the intermediate viewpoints. Examples of each intermediate viewpoint position include a horizontal position (horizontal distance on a plane from the reference viewpoint) and a vertical position (vertical distance on a plane from the reference viewpoint) of each intermediate viewpoint. Examples of the map information of each intermediate viewpoint and the associated data include map information (e.g., Equirectangular) of the 360 video storage format, a 360 video reference direction (reference point on the equator, and point of the zenith). By using this map information, information (light rays) that can be observed in a case of viewing a direction from the intermediate viewpoint can be identified as being recorded in any region of the image data recorded in the specified 360 video storage format.

As described above, since the intermediate viewpoint configuration unit 9 and the intermediate viewpoint configuration unit 16 arrange the intermediate viewpoints at the lattice points, the intermediate viewpoints in the vicinity of the target viewpoint can be easily identified. Obtaining the target viewpoint through synthesis from the nearby intermediate viewpoints of the lattice points can limit the maximum value of the number of 360 video decoding required for the target viewpoint synthesis. For example, the maximum value of the number of 360 video decoding can be limited to the maximum value of the lattice points in the vicinity of any target point (4 in the case of a square lattice on a plane).

The lattice points at which the intermediate viewpoint configuration unit 9 and the intermediate viewpoint configuration unit 16 arrange the intermediate viewpoints are preferably lattice points of a square lattice (uniform vertical spacing and horizontal spacing of adjacent intermediate viewpoints). Since the intermediate viewpoint configuration unit 9 and the intermediate viewpoint configuration unit 16 arrange the intermediate viewpoints at the lattice points of a square lattice, intermediate viewpoints in the vicinity of the target viewpoint can be further easily identified. For example, rounding in units of lattice spacing can be applied to coordinates of the target viewpoint to derive nearby intermediate viewpoints.

The reference directions of all of the intermediate viewpoints (360 video) configured by the intermediate viewpoint configuration unit 9 and the intermediate viewpoint configuration unit 16 are preferably the same. Matching the reference directions of the intermediate viewpoints by the intermediate viewpoint configuration unit 9 and the intermediate viewpoint configuration unit 16 can simplify the retrieval of the pixels of the intermediate viewpoints. More particularly, an algorithm common to the interconversion between vectors on the virtual space and positions on the image of the corresponding intermediate viewpoints can be applied.

Matching the reference directions of the intermediate viewpoints by the intermediate viewpoint configuration unit 9 and the intermediate viewpoint configuration unit 16 can simplify stereo matching. For example, in a case that the reference directions of the two intermediate viewpoints that are horizontally aligned match and the circles representing the equators of the two intermediate viewpoints lie on the same plane, the depth can be estimated by comparison of lines of the identical position in each image of the two intermediate viewpoints.

### Planar Lattice

A common property of lattice points in a planar lattice will be described below. Lattice points at which the intermediate viewpoint configuration unit 9 and the intermediate viewpoint configuration unit 16 arrange intermediate viewpoints are arranged at intersection points of a parallel straight line group and a parallel straight line group (Each parallel straight line group is constituted by multiple straight lines. All the straight lines are parallel to each other and the spacings of adjacent straight lines are equidistant).

Each lattice point at which the intermediate viewpoint configuration unit 9 and the intermediate viewpoint configuration unit 16 arrange intermediate viewpoints includes lattice points (adjacent lattice points) adjacent to each other along a straight line. As a result, the intermediate viewpoint configuration unit 9 and the intermediate viewpoint configuration unit 16 can utilize the adjacent lattice points as the nearby lattice points. Such an effect is effective in simplifying the selection of the nearby viewpoints and limiting the upper limit of the viewpoints.

The density of the lattice points at which the intermediate viewpoint configuration unit 9 and the intermediate viewpoint configuration unit 16 arrange intermediate viewpoints is constant (the expected value of the lattice point density in a case of randomly selecting any range is constant). Thus, even in a case that any position in the lattice is selected as the target viewpoint position, the expected value of the distance to the intermediate viewpoint near the target viewpoint is constant. Such an effect is effective for quality assurance of the target viewpoint obtained through synthesis.

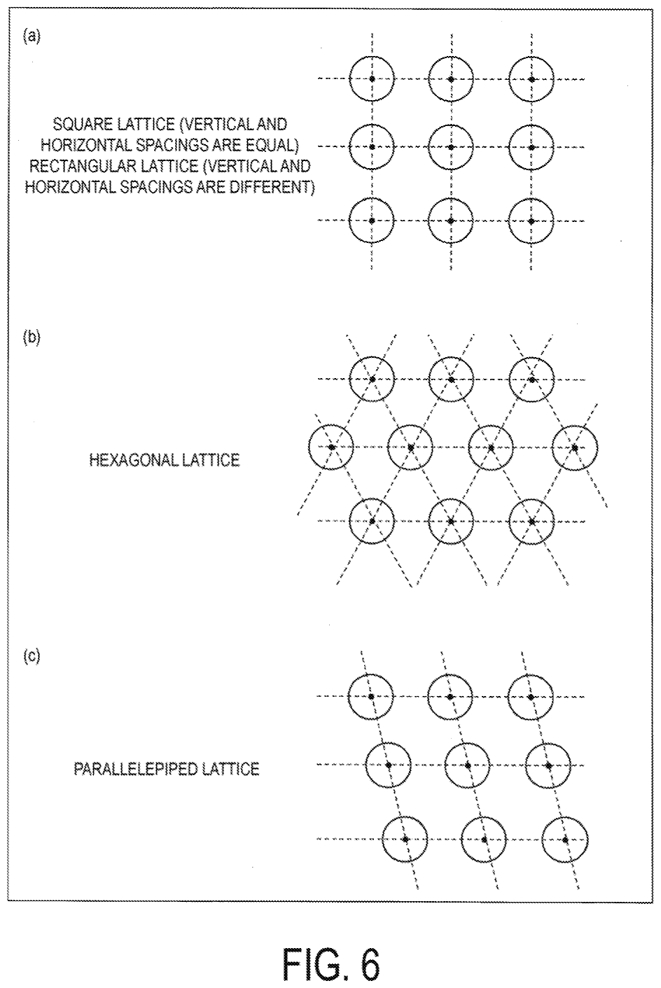

The lattice points may be other than the lattice points of the square lattice, so long as the lattice points at which the intermediate viewpoint configuration unit 9 and the intermediate viewpoint configuration unit 16 arrange intermediate viewpoints satisfy the conditions described above. FIG. 6 illustrates examples of a lattice including lattice points satisfying each of the conditions described above. (a) of FIG. 6 illustrates a square lattice in which the spacing between adjacent lattice points in the vertical or lateral directions is equidistant (which may be a rectangle lattice where the spacing between adjacent lattice points in either the vertical direction or the lateral direction is equidistant). (b) of FIG. 6 illustrates a hexagonal lattice, and (c) of FIG. 6 illustrates a parallelepiped lattice.

As described above, by using lattice points, the distance between intermediate viewpoints adjacent in at least one dimension direction among the multiple intermediate viewpoints configured by the intermediate viewpoint configuration unit 9 and the intermediate viewpoint configuration unit 16 can be equal. This allows for easy identification of a nearby intermediate viewpoint relative to the target viewpoint.

Alternatively, by using lattice points, the multiple intermediate viewpoints configured by the intermediate viewpoint configuration unit 9 and the intermediate viewpoint configuration unit 16 can be arranged regularly in the two-dimensional directions for a straight line or curved line coordinate system of two or more dimensions. This allows for further easy identification of a nearby intermediate viewpoint relative to the target viewpoint.

### Spatial Lattice

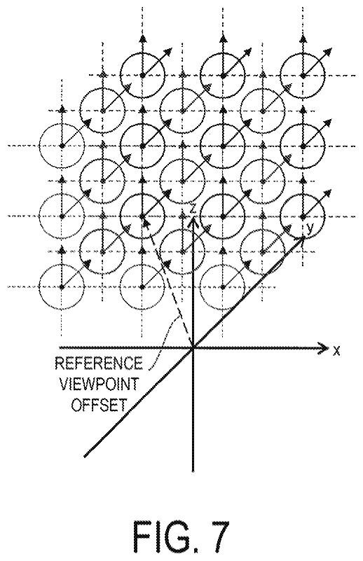

An example in which the intermediate viewpoint configuration unit 9 and the intermediate viewpoint configuration unit 16 arrange intermediate viewpoints in a spatial lattice in steps S1 and S12 respectively will be described below in detail with reference to FIG. 7. FIG. 7 is a diagram illustrating multiple intermediate viewpoints arranged at respective lattice points in three-dimensional coordinates. For example, as illustrated in FIG. 7, the intermediate viewpoint configuration unit 9 and the intermediate viewpoint configuration unit 16 arrange intermediate viewpoints at lattice points regularly arranged in three-dimensional directions in a straight line coordinate system of three or more dimensions (which may be a curved line coordinate system). The intermediate viewpoint configuration unit 9 and the intermediate viewpoint configuration unit 16 configure definition information regarding the intermediate viewpoints illustrated below.

For example, the intermediate viewpoint configuration unit 9 and the intermediate viewpoint configuration unit 16 configure the position and orientation of the lattice within the virtual space as the definition information of the intermediate viewpoints. An example of the definition information of the position of the lattice within the virtual space includes the reference viewpoint offset illustrated in FIG. 7. Examples of the definition information of the orientation of the lattice in the virtual space includes a horizontal vector, a vertical vector, and a depth vector, which are lattice axis vectors.

For example, the intermediate viewpoint configuration unit 9 and the intermediate viewpoint configuration unit 16 configure the number of intermediate viewpoints, each intermediate viewpoint position, map information of each intermediate viewpoint and associated data, and the like, as the definition information of the intermediate viewpoints. Examples of each intermediate viewpoint position include a horizontal position, a vertical position, and a depth position (offset from the reference viewpoint) of each intermediate viewpoint. Examples of the map information of each intermediate viewpoint and the associated data include map information of the 360 video storage format, and a 360 video reference direction (reference point on the equator, point of the zenith).

Note that the spatial lattice and the above-described planar lattice do not result in essential difference except that the axes of the lattice (straight line group) increases. Therefore, it is effective for the intermediate viewpoint configuration unit 9 and the intermediate viewpoint configuration unit 16 to arrange intermediate viewpoints at lattice points regardless of plane or space.

As described above, the multiple intermediate viewpoints configured by the intermediate viewpoint configuration unit 9 and the intermediate viewpoint configuration unit 16 are arranged regularly in the three-dimensional directions for a straight line or curved line coordinate system of three or more dimensions. This allows for further easy, identification of a nearby intermediate viewpoint relative to the target viewpoint.

Arrangements Other than Lattice Points

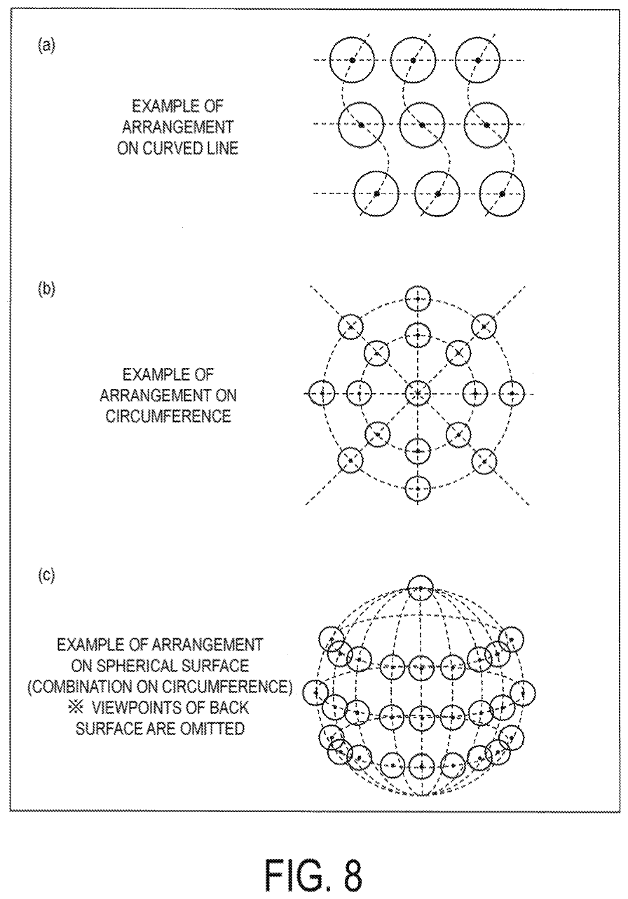

Positions on the space at which the intermediate viewpoint configuration unit 9 and the intermediate viewpoint configuration unit 16 arrange intermediate viewpoints may be positions other than lattice points. Each of (a) to (c) of FIG. 8 is a diagram illustrating an example other than lattice points. (a) of FIG. 8 illustrates an example in which intermediate viewpoints arranged at intersection points of multiple curved lines where the spacing between adjacent curves is equidistant and multiple straight lines where the spacing between adjacent straight lines is equidistant. (b) of FIG. 8 illustrates an example in which intermediate viewpoints are arranged at intersection points of multiple concentric circles and multiple radiation lines centered on the center of the multiple concentric circles. (c) of FIG. 8 illustrates an example in which intermediate viewpoints are arranged at intersection points of multiple meridians on a spherical surface and multiple latitude lines on the spherical surface (intermediate viewpoints of the back surface are omitted).

As illustrated in each example of (a) to (c) of FIG. 8, the intermediate viewpoint configuration unit 9 and the intermediate viewpoint configuration unit 16 arranges intermediate viewpoints evenly spaced on defined curved lines or arranges the intermediate viewpoints evenly spaced on a defined circumference (which may be equiangular spacing), and this facilitates search of intermediate viewpoints in the vicinity of the target viewpoint. Positions of the intermediate viewpoints can be easily parameterized.

Arrangement of Intermediate Viewpoints in Accordance with Configurable Range of Target Viewpoint

The arrangement of intermediate viewpoints configured in each of steps S1 and S12 by the intermediate viewpoint configuration unit 9 and the intermediate viewpoint configuration unit 16 may be arrangement in accordance with the configurable range (predetermined range) of the target viewpoint configured by the target viewpoint configuration unit 17. The configurable range of the target viewpoint here can be a predetermined range for a straight line or curved line coordinate system of one or more dimensions.

For example, the intermediate viewpoint configuration unit 9 and the intermediate viewpoint configuration unit 16 may configure intermediate viewpoints within the target viewpoint configurable range (within a predetermined range) configured by the target viewpoint configuration unit 17, This makes it possible to reduce image information that is not utilized during the target viewpoint synthesis. In a case that the target viewpoint configurable range configured by the target viewpoint configuration unit 17 is wider in a specific direction relative to other directions, the intermediate viewpoint configuration unit 9 and the intermediate viewpoint configuration unit 16 preferably arrange the multiple intermediate viewpoints on a straight line or on a plane along the specific direction. As a result, the intermediate viewpoints required during the target viewpoint synthesis are appropriately arranged within a predetermined range.

The intermediate viewpoint configuration unit 9 and the intermediate viewpoint configuration unit 16 may arrange intermediate viewpoints at the center and end of the target viewpoint configurable range configured by the target viewpoint configuration unit 17. The target viewpoint configuration unit 17 may configure the target viewpoint configurable range in a plane, and the intermediate viewpoint configuration unit 9 and the intermediate viewpoint configuration unit 16 may arrange intermediate viewpoints at lattice points within the target viewpoint configurable range on the plane.

Arrangement of Intermediate Viewpoints in Accordance with Depth of Imaging Target

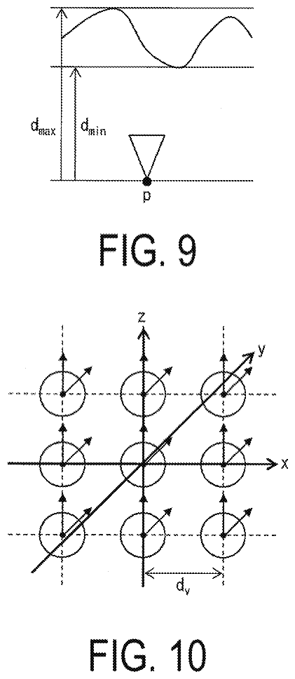

The arrangement of intermediate viewpoints configured in each of steps S1 and S12 by the intermediate viewpoint configuration unit 9 and the intermediate viewpoint configuration unit 16 may be arrangement in accordance with the depth of the imaging target indicated by the image data received in step S0 by the communication unit 7. FIG. 9 is a diagram schematically illustrating a camera p for capturing an imaging target, and a maximum depth dₘₐₓ and a minimum depth dₘᵢₙ of the imaging target. For example, the intermediate viewpoint configuration unit 9 and the intermediate viewpoint configuration unit 16 refer to an index indicating the magnitude of the spatial variation of the depth of the imaging target, and configures the spacing between adjacent intermediate viewpoints to be narrow in a case that the variation is large. An example of the index includes a depth range and the like of the imaging target. For example, in a case that the minimum depth horn the intermediate viewpoint to the imaging target is the same, the greater a range of the depth of the imaging target, the narrower the spacing between adjacent intermediate viewpoints.

Another example of the index includes a combination of the depth range of the imaging target and the minimum depth of the imaging target

For example, the intermediate viewpoint configuration unit 9 and the intermediate viewpoint configuration unit 16 may configure spacing of adjacent intermediate viewpoints, based on following Equation (1) representing the magnitude of the spatial variation of the depth of the imaging target.

p=(dₘₐₓ−dₘᵢₙ)/dₘᵢₙ Equation (I)

The intermediate viewpoint configuration unit 9 and the intermediate viewpoint configuration unit 16 configure the spacing between adjacent intermediate viewpoints to be wider as the parameter p is smaller, and configure the spacing between adjacent intermediate viewpoints to be narrower as the parameter p is larger in Equation (1) above.

### Imaging Apparatus 2

The imaging apparatus 2 (camera) according to the present embodiment will be described below in detail. As described above, the extended 360 video data recording and reproducing system 1 according to the present embodiment includes multiple imaging apparatuses (not illustrated) having a similar configuration to that of the imaging apparatus 2, and each of the multiple imaging apparatuses captures a real world scene (imaging target), and outputs each of the information of (1) to (3) below to the communication unit 7.

### (1) Source Video

The source video corresponds to image data captured by each of the imaging apparatuses. In a case that the imaging apparatus is a 360 camera, the source video is a 360 image (full orientation image) captured by the 360 camera. In a case that the imaging apparatus is a common camera (a narrow angle camera), the source video is an image captured by the narrow angle camera.

### (2) Camera Position Information

Camera position information indicates a position or a direction of each of the imaging apparatuses in the real space. For example, the camera position information may be information indicating a spatial position of each of the imaging apparatuses with reference to a predetermined position in the real space. The camera position information may be information indicating an imaging direction of each of the imaging apparatuses with respect to a predetermined direction. The camera position information may be information indicating an imaging angle of each of the imaging apparatuses.

### (3) Scene Model Information

The scene model information is information that approximates the 3D shape of the imaging range. In the present embodiment, the scene model information is assumed to be depth information obtained by measuring a distance from one predetermined point to the periphery. The scene model information may also utilize a 3D model, multiple depth information, or a combination thereof.

Note that the extended 360 video data recording device 3 according to the present embodiment may process an image of a virtual object captured by a virtual camera synthesized by 3DCG or the like in place of the source video output by the multiple imaging apparatuses, as source video (image data). In that case, virtual camera position information is required associated with the source video.

### Intermediate Viewpoint Configuration Unit 9

The intermediate viewpoint configuration unit 9 according to the present embodiment will be described below in detail with reference to FIG. 10. FIG. 10 is a diagram illustrating multiple intermediate viewpoints arranged along the XZ plane in three-dimensional coordinates. Note that, for the example of the definition information of the intermediate viewpoints configured by the intermediate viewpoint configuration unit 9, reference is made to the example described in the above section (Intermediate Viewpoint Definition).

A more detailed example of the arrangement of intermediate viewpoints configured by the intermediate viewpoint configuration unit 9 is illustrated below. For example, the intermediate viewpoint configuration unit 9 arranges intermediate viewpoints at lattice points on a plane. The intermediate viewpoint configuration unit 9 configures a three-axis (x, y, z) orthogonal coordinate system in a virtual space to arrange intermediate viewpoints.

An example of a data configuration related to the arrangement of intermediate viewpoints configured by the intermediate viewpoint configuration unit 9 is illustrated below. For example, the intermediate viewpoint configuration unit 9 configures the definition information of the lattice position and orientation within the virtual space. Examples of the definition information include (1) and (2) below.

(1) Reference viewpoint offset: uₒ=(0, 0, 0)
(2) Lattice orientation vector on a plane:

uᵥ=(0, 0, dᵥ) . . . Vertical: positive direction of z-axis

uₕ=(dᵥ, 0, 0) Horizontal: positive direction of x-axis

Alternatively, for example, the intermediate viewpoint configuration unit 9 configures the number of intermediate viewpoints (the number of intermediate viewpoints=9 (3×3)). Alternatively, for example, the intermediate viewpoint configuration unit 9 configures each intermediate viewpoint position illustrated below.
uₒ, uₒ±uᵥ, uₒ±uₕ, uₒ±uᵥ±uₕ (any Sign is Possible for Double Sign)

Alternatively, for example, the intermediate viewpoint configuration unit 9 configures map information of each intermediate viewpoint and the associated data. Examples of the map information include map information (e.g., Equirectangular, etc.) in a 360 video storage format, and 360 video reference direction. The 360 video reference direction may be a reference point on the equator (the reference point on the equator=(0, 1, 0) corresponds to the center of the image) or a point of the zenith (the point of the zenith=(0, 0, 1) corresponds to the top center (or top edge) of the image), or the like.

### Intermediate 360 Video Set Generation Unit 10

Hereinafter, the intermediate 360 video set generation unit 10 according to the present embodiment will be described in detail. For example, the intermediate 360 video set generation unit 10 generates an intermediate 360 video set (including multiple intermediate viewpoint image data), based on the intermediate viewpoint definition configured by the intermediate viewpoint configuration unit 9 and the source video, camera position information, and scene model information received by the communication unit 7 from the imaging apparatus 2, in step S2 described above. Here, the intermediate 360 video set indicates a group of image data corresponding to the image captured by placing a virtual camera in each intermediate viewpoint defined by the intermediate viewpoint definition.

Schematically, the intermediate 360 video set generation unit 10 generates a 360 video group captured by virtual cameras provided in the intermediate viewpoints, from the source video captured by the actual camera. An effect of intermediate 360 video set generation unit 10 performing the generation process of an intermediate 360 video set includes that determining a predetermined arrangement for the intermediate viewpoints enables the image synthesis process to be performed without knowledge of the actual camera arrangement during target viewpoint synthesis.

For example, since assuming the nature of a particular camera arrangement can optimize the viewpoint synthesis process, matching the intermediate viewpoint with its camera arrangement provides the advantage of being able to perform an optimized target viewpoint synthesis process while leaving freedom to the actual camera position. In general, in application of generating and displaying a corresponding image following the user-specified viewpoint, it is effective to provide the generation process of an intermediate 360 video set because a real time and low delay target viewpoint synthesis process is required.

In addition, data representation of the intermediate 360 video set generated by the intermediate 360 video set generation unit 10 is preferably based on the coding and file format of the multi-viewpoint image. Since an HMD reproducing the target viewpoint image obtained through synthesis based on the intermediate 360 video set is optimized for rendering a 360 video, the intermediate 360 video set generated by the intermediate 360 video set generation unit 10 is preferably in a format with a large amount of compatibility (common portion) with the HMD.

From the demand of the reproducing process of the target viewpoint image at real time and low delay, the intermediate viewpoint image data generated by the intermediate 360 video set generation unit 10 is preferably in a format that simplifies the interpolation process. From the demand of the decoding process, the intermediate 360 video set generated by the intermediate 360 video set generation unit 10 is preferably constituted of a minimum number of 360 video frames as information that the viewpoint image generation unit 18 may collectively access during the target viewpoint image reproducing process.

By the intermediate 360 video set generation unit 10 generating the intermediate 360 video set, multiple images with multiple intermediate viewpoints as viewpoints can be acquired. As a result, there is no need to provide a large number of cameras in positions where the viewpoints are to be reproduced in the real world, and the costs of equipment and provision can be reduced.

### Intermediate 360 Video Set Generation Process

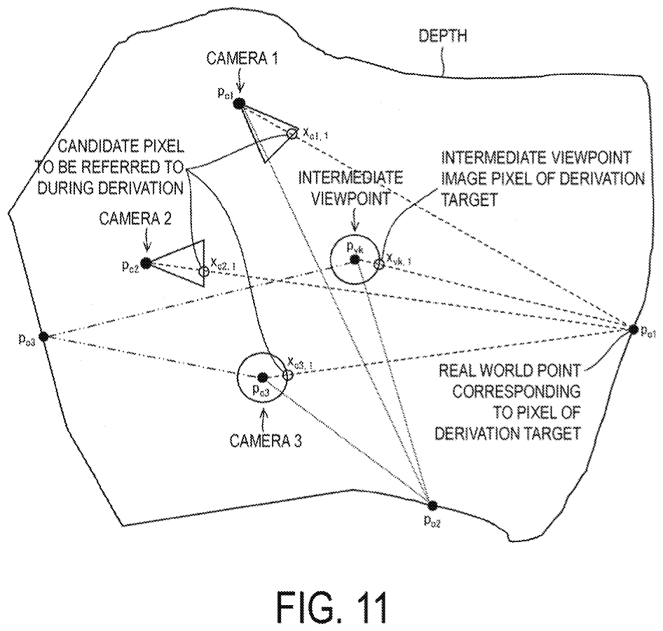

Hereinafter, the intermediate 360 video set generation process (step S2 described above) by the intermediate 360 video set generation unit 10 will be described in detail with reference to FIG. 11. FIG. 11 is a diagram schematically illustrating a camera P_{c1}, a camera P_{c2}, and a camera P_{c3} having a similar configuration to that of the imaging apparatus 2, and an intermediate viewpoint Pᵥₖ, included in scene model information (depth).

The multiple imaging apparatuses including the camera P_{c1}, the camera P_{c2}, and the camera P_{c3} transmit, for example, the data of (1) to (3) below to the communication unit 7 of the extended 360 video data recording device 3.

### (1) Source Video

V_{c1}, V_{c2}, . . . , V_{cN}

### (2) Camera Position Information

Camera position
p_{c1}, p_{c2}, . . . , p_{cN}

Camera field of view (direction+viewing angle)
φ_{c1}, φ_{c2}, . . . , φ_{cN}

### (3) Scene Model Information (Depth Data)

D₀

The intermediate 360 video set generation unit 10 generates the data of (1) and (2) below in step S2 described above.

### (1) Intermediate 360 Video

Vᵥ₁, Vᵥ₂, . . . , V_{vK}

### (2) Intermediate Viewpoint Position

Example: Parametric representation by function
pᵥₖ=f(k)(k=1 . . . K)

The procedure of the intermediate 360 video set generation process by the intermediate 360 video set generation unit 10 will be described below. The intermediate 360 video set generation unit 10 performs the following processes of (1) to (4) below for each intermediate viewpoint k∈[1, K], for example, and derives intermediate viewpoint video Vᵥₖ. Note that, in (1) to (4) below, a method for deriving the intermediate viewpoint video Vᵥₖ will be described as a procedure for deriving a pixel value for each position on the intermediate viewpoint image Iᵥₖ corresponding to the intermediate viewpoint image data at a specific time.

### (1) Target Position Configuration on Image

The intermediate 360 video set generation unit 10 configures the target position on the intermediate viewpoint image Iᵥₖ as x_{vk,m}.

### (2) Spatial Corresponding Position Derivation

Next, the intermediate 360 video set generation unit 10 derives a position pₒₘ corresponding to a point on the space corresponding to x_{vk,m}, based on the intermediate viewpoint position pᵥₖ, the target position and the depth data D₀.

### (3) Corresponding Position Derivation of Each Camera Image

Next, the intermediate 360 video set generation unit 10 derives a position x_{cn,m} corresponding to the spatial position pₒₖ on the image of the camera n, based on pₒₖ and p_{cn.}

### (4) Derivation of Target Pixel Value

Next, the intermediate 360 video set generation unit 10 configures the pixel value at the position x_{cn,m} on the image I_{cn} of the camera n to the pixel value at the position x_{vk,m} of the image Iᵥₖ. Note that in a case that there is a pixel available for multiple cameras, the intermediate 360 video set generation unit 10 selects a pixel on a predetermined criterion as the pixel at the position x_{vk,m} of the image Iᵥₖ.

As a specific example of (4) above, for example, the intermediate 360 video set generation unit 10 selects and refers to the input image data (pixel at the position x_{cn,m} on the image Iᵥₖ) representing the image captured by the camera with the highest resolution relative to the imaging target (corresponding to the pixels at the position x_{vk,m} of the image Iᵥₖ) (or the camera closest to the imaging target) and generates intermediate viewpoint image data indicating the image of the imaging target. Alternatively, for example, the intermediate 360 video set generation unit 10 refers in preference to the input image data (pixel at the position x_{cn,m} on the image representing the image captured by the camera having the optical axis closest to the direction from the target intermediate viewpoint (position pᵥₖ) to the imaging target (corresponding to the pixel at the position x_{vk,m} of the image Iᵥₖ) and generates the intermediate viewpoint image data (intermediate 360 video set) indicating the image of the imaging target with the target intermediate viewpoint as the viewpoint. Here, reference in preference to specific input image data also includes, in addition to reference only to specific input image data, increasing a weight for a specific input image data (e.g., the weight for the weighted average of the pixel values) in a case that reference is made to both the specific input image data and other input image data. By employing each of the above-described configurations, intermediate viewpoint image data can be generated based on the input image data closest to the actual imaging target.

The intermediate 360 video set generation unit 10 searches each light ray of the intermediate viewpoint by ray tracing under the assumption of non-occlusion and Lambertian reflection and generates the 360 image at the intermediate viewpoint. More specifically, the intermediate 360 video set generation unit 10 refers to at least one of the multiple input image data received by the communication unit 7, and generates the intermediate viewpoint image data (intermediate 360 video set) by ray tracing based on each position of the camera which has captured the image indicated by the input image data, parameters of the camera, each position of the multiple intermediate viewpoints configured by the intermediate viewpoint configuration unit 9, and the depth of each imaging target of the image (scene model information). This makes it possible to generate intermediate viewpoint image data based on the actual imaging target.

Note that the individual 360 videos included in the intermediate 360 video set is defined as a video that has an image that maps the light rays incident on the intermediate viewpoint to a predetermined model (e.g., a sphere) every time as a frame for each time. Examples of exemplary mapping here include Equirectangular, and cube map. In the intermediate 360 video set generation process in the present embodiment, it is preferred to apply a common mapping method to all intermediate 360 videos, although not dependent on a specific mapping method. Thus, the target viewpoint synthesis process can be simplified.

### Coding and Multiplexing Unit 11

The coding and multiplexing unit 11 according to the present embodiment will be described below in detail. In step S3, the coding and multiplexing unit 11 generates and outputs extended 360 video data packaged by the coding and multiplexing the intermediate 360 video set generated by the intermediate 360 video set generation unit 10. For example, the coding and multiplexing unit 11 codes each 360 video included in the intermediate 360 video set in a predetermined image coding scheme (e.g., HEVC). Note that the image coding scheme is preferably a scheme for coding a 360 video of the target intermediate viewpoint by utilizing a correlation with a 360 video of an adjacent intermediate viewpoint.

For example, the coding and multiplexing unit 11 codes and multiplexes at least 360 video set data and map data. The coding scheme applied by the coding and multiplexing unit 11 is preferably a scheme to selectively read intermediate 360 video data of the intermediate viewpoint at a predetermined time.

For example, the coding and multiplexing unit 11 may code and multiplex the 360 video set data with information indicating the above-described target viewpoint configurable range (predetermined range) as additional information. This allows the range to be configured without analyzing the position of the intermediate viewpoint.

The coding and multiplexing unit 11 (corresponding to the multiplexing unit in the claims) preferably multiplexes 360 videos (intermediate viewpoint image data) generated by applying a common mapping by the intermediate 360 video set generation unit 10 (corresponding to the intermediate viewpoint image data generation unit in the claims). As a result, since only the image to which the common mapping has been applied is needed to be processed, the target viewpoint synthesis process can be simplified.

The coding and multiplexing unit 11 preferably multiplexes 360 videos (intermediate viewpoint image data) indicating images with the intermediate viewpoints as the viewpoints in which the reference directions are identical. As a result, since only the image with the viewpoint of the intermediate viewpoint in which the reference directions are identical is only processed, the target viewpoint synthesis process can be simplified.

The coding and multiplexing unit 11 preferably multiplexes each 360 video (intermediate viewpoint image data) and map data associating respective 360 videos and multiple intermediate viewpoints. As a result, since an image corresponding to any intermediate viewpoint can easily be determined, the target viewpoint synthesis process can be simplified.

### Format of Extended 360 Video Data

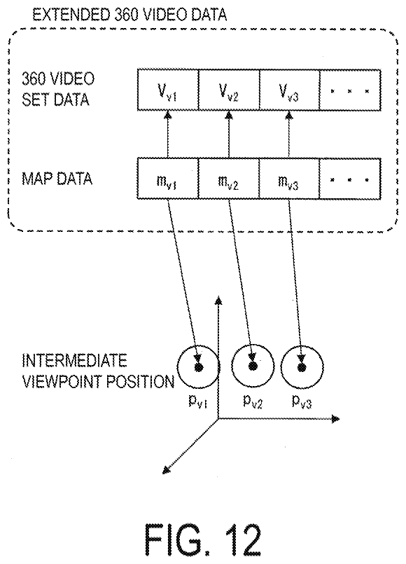

Hereinafter, the format of the extended 360 video data, which is intermediate viewpoint image data coded and multiplexed by the coding and multiplexing unit 11, will be described in detail with reference to FIG. 12. FIG. 12 is a schematic diagram illustrating the extended 360 video data and corresponding intermediate viewpoints.

The extended 360 video data generated by the coding and multiplexing unit 11 is data in which image coding has been applied to each intermediate 360 video (intermediate viewpoint image data). The extended 360 video data generated by the coding and multiplexing unit 11 preferably includes map data. The map data is data indicating the association between each 360 video data and each intermediate viewpoint position. Examples of the contents of the individual maps included in the map data include a 360 video storage position, and an intermediate viewpoint position. For example, the 360 video storage position is indicated by a byte offset from the data lead. The intermediate viewpoint position is indicated by the relative position from the defined reference point. In another example, the 360 video storage position is indicated by URL of a site in which the 360 video is stored. The intermediate viewpoint position is indicated by an intermediate viewpoint index.

### Viewpoint Image Generation Unit 18

The viewpoint image generation unit 18 according to the present embodiment will be described below in detail. With reference to the intermediate viewpoint image data (intermediate 360 video set) demultiplexed by the decoding and demultiplexing unit 15, the viewpoint image generation unit 18 generates target viewpoint image data indicating an image from the target viewpoint configured by the target viewpoint configuration unit 17. More specifically, the viewpoint image generation unit 18 generates the target viewpoint image data from image information of the 360 video included in the intermediate 360 video set, the information required to obtain the target viewpoint image through synthesis. Here, the viewpoint image generation unit 18 calculates and derives the 360 video or image region to be utilized from the target viewpoint (viewpoint position and gaze direction) and the intermediate viewpoint position.

The viewpoint image generation unit 18 preferably refers to intermediate viewpoint image data (360 video) indicating an image corresponding to a viewpoint(s), one or two points of intermediate viewpoints at a position closest to the position of the target viewpoint, and generates target viewpoint image data (360 video) indicating an image from the target viewpoint. This can generate an image corresponding to a viewpoint, a more approximated target viewpoint to the actual viewpoint.

Although the following describes a method for selecting two intermediate viewpoints in the vicinity of the target viewpoint, the target viewpoint image generation method is not limited thereto. For example, a method may be employed to generate a target viewpoint image by merging the 360 video of three or more intermediate viewpoints, or to select an intermediate viewpoint in conjunction with additional included depth information.

### Viewpoint Image Generation Process

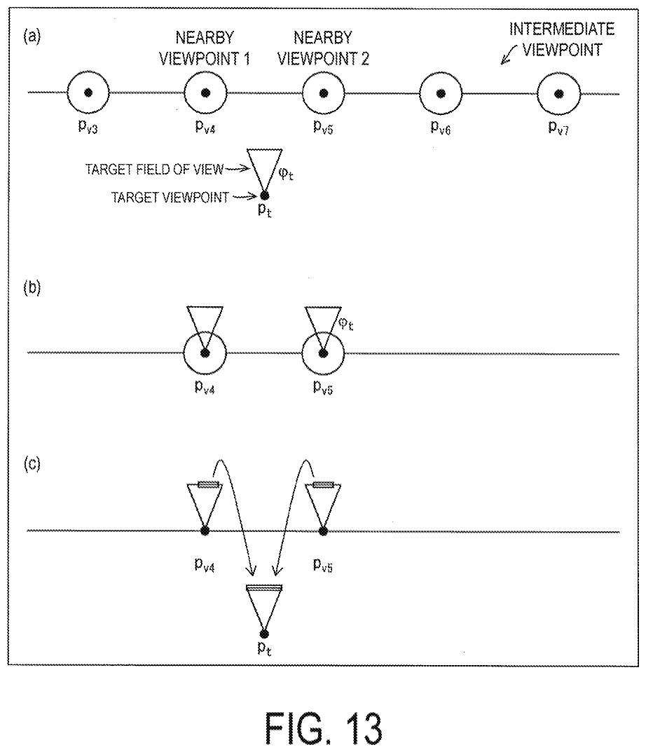

The viewpoint image generation process by the viewpoint image generation unit 18 according to the present embodiment will be described in detail below with reference to FIG. 13. (a) to (c) of FIG. 13 are diagrams schematically illustrating each step of the viewpoint image generation process described below.

The viewpoint image generation unit 18 refers to the data of (1) and (2) below, for example.

### (1) Intermediate 360 Video Data

Vᵥ₁, Vᵥ₂, . . . , V_{vK}

### (2) Intermediate Viewpoint Position

Example: Parametric representation by function
pᵥₖ=f(k) (k=1 . . . K)

The viewpoint image generation unit 18 refers to, for example, a target viewpoint pₜ, which is target viewpoint information configured by the target viewpoint configuration unit 17, and a target field of view φₜ.

Then, the viewpoint image generation unit 18 generates the target viewpoint image (video) Vₜ by referring to these information.

A procedure of the viewpoint image generation process by the viewpoint image generation unit 18 will be described below. The viewpoint image generation unit 18 generates the target viewpoint image, based on information of the intermediate 360 video set in the following procedures of (1) to (3). Note that the derivation process of the image Iₜ at a specific time of the target viewpoint image V₁ will be described below.

### (1) Nearby Viewpoint Configuration

As illustrated in FIG. 13(a), the viewpoint image generation unit 18 selects a representative viewpoint pᵥ₄ and a representative viewpoint pᵥ₅ in the vicinity of the target viewpoint pₜ. Alternatively, the viewpoint image generation unit 18 selects one point of a representative viewpoint as a nearby viewpoint in a case that pₜ matches a particular pᵥₖ, and otherwise selects two points of representative viewpoints as nearby viewpoints in order of nearness to the target viewpoint.

### (2) Viewpoint Image Synthesis of Nearby Samples

As illustrated in FIG. 13(b), the viewpoint image generation unit 18 generates an image with a viewpoint from the nearby viewpoint, which has the same direction and the same field of view as the target field of view φₜ, from the 360 video of each nearby viewpoint.

### (3) Final Viewpoint Image Synthesis

In a case that the number of nearby samples is one point, the viewpoint image generation unit 18 applies the viewpoint interpolation process to the image derived in (2) to obtain the final viewpoint image through synthesis, and in a case that the number of nearby samples is two points, applies the viewpoint interpolation process to the image extracted from the two nearby viewpoints to obtain the final viewpoint image through synthesis, as illustrated in FIG. 13(c).

As described above, the viewpoint image generation unit 18 selects 360 videos of two nearby points corresponding to the target viewpoint, and converts each video to an image corresponding to the target field of view. Then, the viewpoint image generation unit 18 generates the target viewpoint image by applying the viewpoint interpolation to the images. This allows the target viewpoint image to be generated by using a limited number (two) of 360 videos. Additionally, according to the above procedure, since the step of (3), which is the last process, usually corresponds to the step of viewpoint interpolation of the camera image, an additional effect is achieved that existing algorithms can be reused. Note that the procedure for directly obtaining the final viewpoint image through synthesis from the two 360 videos of nearby viewpoint 1 and nearby viewpoint 2, which are results of the above (1), may be used. In this configuration, reuse of existing algorithms is difficult, but the effect of reducing the required amount of intermediate video memory can be achieved.

### Summary of Embodiment 1

As described above, the extended 360 video data recording device 3 (image data generation device) according to the present embodiment refers to at least one of multiple input image data representing images from multiple different viewpoints from each other and generate intermediate viewpoint image data indicating an image corresponding to the viewpoints included in multiple intermediate viewpoints regularly arranged in at least one dimension direction for a straight line or curved line coordinate system of one or more dimensions.

The extended 360 video data reproducing device 4 (image data generation device) according to the present embodiment refers to the intermediate viewpoint image data generated by the extended 360 video data recording device 3, and generates the target viewpoint image data indicating the image from the target viewpoint.

As a result, the target viewpoint image can be generated based on the multiple intermediate viewpoints regularly arranged, and thus the generation and reproducing of the target viewpoint image can be simplified compared to a case that the viewpoint image is generated directly from the camera image. The intermediate viewpoints in the vicinity of the target viewpoint required for viewpoint synthesis can be easily identified by using limitations. The viewpoint synthesis is possible only from the intermediate viewpoint image data in the vicinity of the target viewpoint, and the decoding process or video memory can be reduced. Since the format of the intermediate viewpoint image can also be the format of 360 video, some of reproducing, algorithms of the target viewpoint image can be shared with the 360 video reproducing of the fixed viewpoint.

### Embodiment 2

Embodiment 2 of the present invention will be described below with reference to the drawings. Note that members having the same function as the members included in the extended 360 video data recording and reproducing system 1 described in Embodiment 1 are denoted by the same reference signs, and descriptions thereof will be omitted.

### Extended 360 Video Data Recording and Reproducing System 20

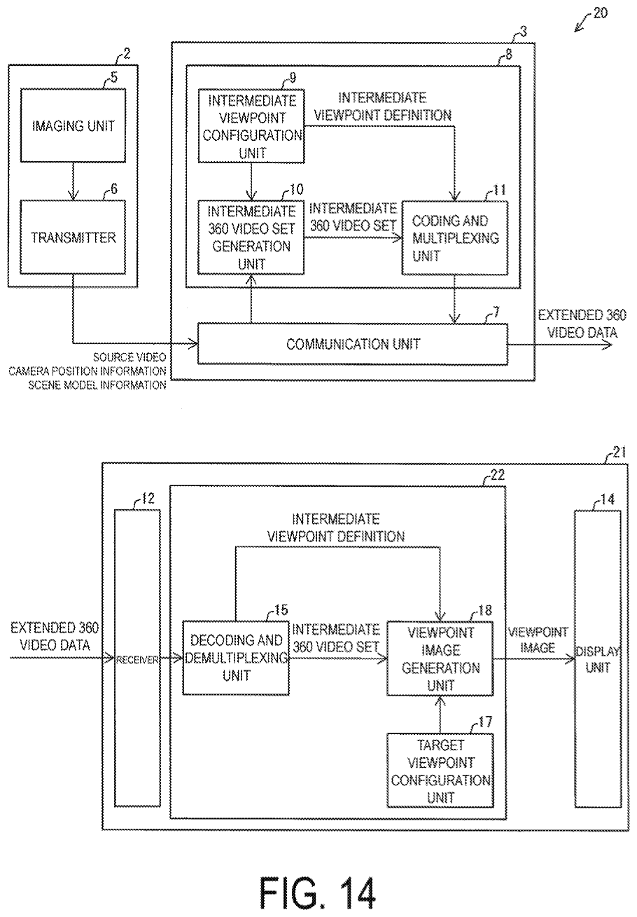

An extended 360 video data recording and reproducing system 20 according to the present embodiment will be described with reference to FIG. 14. FIG. 14 is a block diagram illustrating a configuration of the extended 360 video data recording and reproducing system 20. As illustrated in FIG. 14, the extended 360 video data recording and reproducing system 20 according to the present embodiment has the same configuration as that of the extended 360 video data recording and reproducing system 1 according to Embodiment 1 except that a processing unit 22 of an extended 360 video data reproducing device 21 does not include the intermediate viewpoint configuration unit 16.

### Intermediate 360 Video Set Generation Method and Target Viewpoint Image Generation Method

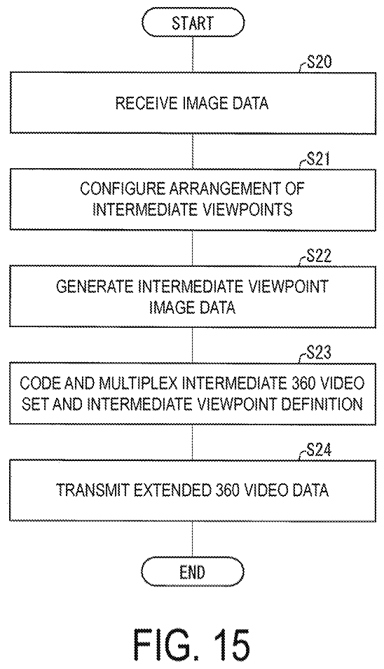

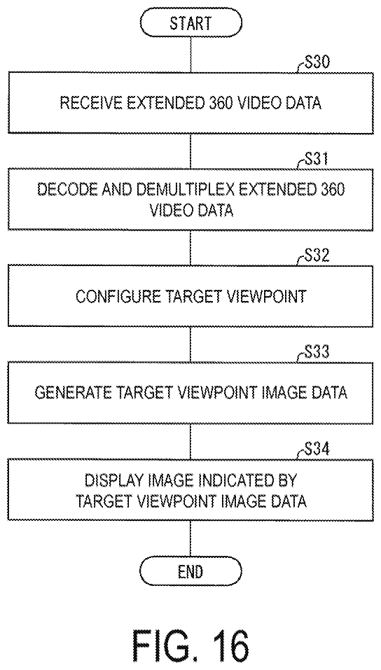

An intermediate 360 video set generation method by the extended 360 video data recording device 3 according to the present embodiment and a target viewpoint image generation method by the extended 360 video data reproducing device 21 according to the present embodiment will be described in detail with reference to FIG. 15 and FIG. 16. FIG. 15 is a flowchart illustrating an example of the intermediate video set generation method by the extended 360 video data recording device 3 according to the present embodiment. FIG. 16 is a flowchart illustrating an example of the target viewpoint image generation method by the extended 360 video data reproducing device 21 according to the present embodiment. Note that detailed descriptions of the same steps as the intermediate 360 video set generation method or the target viewpoint image generation method according to Embodiment 1 are omitted.

### Intermediate 360 Video Set Generation Method

Each step of the intermediate 360 video set generation method according to the present embodiment will be described below with reference to FIG. 16.

First, the communication unit 7 receives the image data transmitted by the imaging apparatus 2 (step S20).

Next, the intermediate viewpoint configuration unit 9 configures multiple intermediate viewpoints regularly arranged in at least one dimension direction for a straight line or curved line coordinate system of one or more dimensions, and transmits information (intermediate viewpoint definition information) regarding the arrangement of the configured intermediate viewpoints to the intermediate 360 video set generation unit 10 and the coding and multiplexing unit 11 (step S21).

Next, the intermediate 360 video set generation unit 10 refers to at least one of the multiple image data received by the communication unit 7, and generates intermediate viewpoint image data indicating images corresponding to the viewpoints included in the multiple intermediate viewpoints arranged based on the configuration of the intermediate viewpoint configuration unit 9 (step S22).

Next, the coding and multiplexing unit 11 codes intermediate viewpoint image data (intermediate 360 video set) generated by the intermediate 360 video set generation unit 10 and the intermediate viewpoint definition information transmitted from the intermediate viewpoint configuration unit 9, and multiplexes respective coded data to generate extended 360 video data (step S23).

Next, the communication unit 7 transmits the extended 360 video data generated by the coding and multiplexing unit 11 to the extended 360 video data reproducing device 21 (step S24).

### Target Viewpoint Image Generation Method

Each step of the target viewpoint image generation method according to the present embodiment will be described below with reference to FIG. 16.

First, the receiver 12 receives the extended 360 video data transmitted by the communication unit 7 of the extended 360 video data recording device 3 (step S30).

The decoding and demultiplexing unit 15 decodes the extended 360 video data received by the receiver 12, demultiplexes the decoded data, and thereby generates an intermediate 360 video set and intermediate viewpoint definition information, reads the generated intermediate viewpoint definition information and configures intermediate viewpoint definition (step S31).

The target viewpoint configuration unit 17 configures a target viewpoint (step S32).

With reference to the intermediate 360 video set demultiplexed by the decoding and demultiplexing unit 15, and the intermediate viewpoint definition configured by the decoding and demultiplexing unit 15, the viewpoint image generation unit 18 generates target viewpoint image data indicating an image from the target viewpoint configured by the target viewpoint configuration unit 17 (step S33).

The display unit 14 displays the image indicated by the target viewpoint image data generated by the viewpoint image generation unit 18 (step S34).

The differences between the intermediate 360 video set generation method and the target viewpoint image generation method according to the present embodiment described above and the intermediate 360 video set generation method and the target viewpoint image generation method according to Embodiment 1 will be described. First, the method according to the present embodiment differs from the method according to Embodiment 1 in that the intermediate viewpoint definition is explicitly signaled. In this way, definition information regarding the intermediate viewpoints is transmitted from the extended 360 video data recording device 3 that has generated the intermediate viewpoint image data, based on the actually captured image data, to the extended 360 video data reproducing device 21, and thus the extended 360 video data reproducing device 21 can refer to the definition information and configure suitable intermediate viewpoints depending on the structure or breadth of the target scene. For example, in a case that the structure of the target scene is complex, the intermediate viewpoint configuration unit 9 configures high density intermediate viewpoints in step S21, and transmits the definition information of the intermediate viewpoints to the coding and multiplexing unit 11, Alternatively, in a case that the structure of the target scene is simple, the intermediate viewpoint configuration unit 9 configures low density intermediate viewpoints in step S21, and transmits the definition information of the intermediate viewpoints to the coding and multiplexing unit 11.

The intermediate viewpoint definition information generated by the intermediate viewpoint configuration unit 9 can be defined as information including at least some of the all parameters required to determine the intermediate viewpoint position. Examples of such parameters include a viewpoint arrangement type representing a type of a coordinate system or lattice, a position of a lattice, a direction of a lattice, a viewpoint spacing, and a viewpoint range. For example, the intermediate viewpoint configuration unit 9 selects the viewpoint arrangement type from a predetermined arrangement (such as a planar square lattice or a simple cubic lattice). The viewpoint spacing generated by the intermediate viewpoint configuration unit 9 may be information indicating the spacing between the viewpoints (e.g., lattice point spacing of the square lattice). The viewpoint range generated by the intermediate viewpoint configuration unit 9 may be information indicating a range of a space in which the viewpoints are arranged.

### Summary of Embodiment 2

As described above, the extended 360 video data recording device 3 according to the present embodiment (corresponding to the image data generation device in the claims) multiplexes respective intermediate viewpoint image data (intermediate 360 video set) and information regarding to definitions of multiple intermediate viewpoints (intermediate viewpoint definition information). Thus, in a case that reference is made to the intermediate viewpoint image data to generate the target viewpoint image data, appropriate intermediate viewpoints can be configured according to the structure or breadth of the target scene with reference to the intermediate viewpoint definition information.

### Embodiment 3

Embodiment 3 of the present invention will be described below with reference to the drawings. Note that members having the same function as the members included in the extended 360 video data recording and reproducing systems 30 described in Embodiment 1 and Embodiment 2 are denoted by the same reference signs, and descriptions thereof will be omitted.

### Extended 360 Video Data Recording and Reproducing System 30

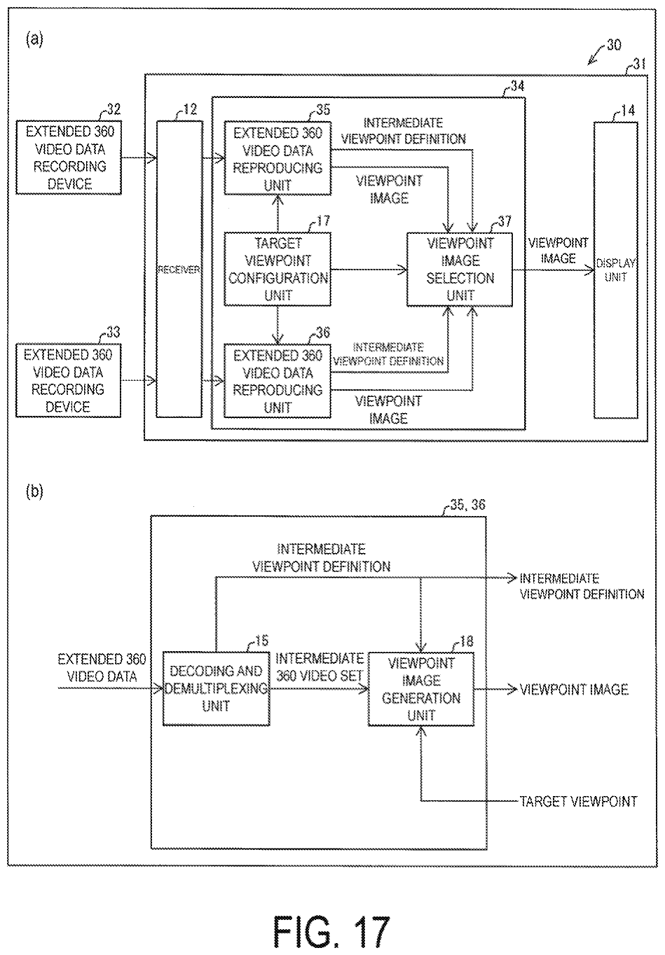

The extended 360 video data recording and reproducing system 30 according to the present embodiment will be described with reference to FIG. 17. (a) of FIG. 17 is a block diagram illustrating a configuration of the extended 360 video data recording and reproducing system 30 according to Embodiment 3 of the present invention. (b) of FIG. 17 is a block diagram illustrating a configuration of an extended 360 video data reproducing unit 35 or an extended 360 video data reproducing unit 36 according to Embodiment 3 of the present invention. As illustrated in (a) of FIG. 17, the extended 360 video data recording and reproducing system 30 according to the present embodiment includes an extended 360 video data recording device 32 and an extended 360 video data recording device 33 having a configuration similar to that of the extended 360 video data recording device 3 according to Embodiment 1 and Embodiment 2, and an extended 360 video data reproducing device 31.

### Extended 360 Video Data Reproducing Device 31

Except a processing unit 34, the extended 360 video data reproducing device 31 has the same configuration as that of the extended 360 video data reproducing device 21 according to Embodiment 2. The processing unit 34 includes an extended 360 video data reproducing unit 35 and an extended 360 video data reproducing unit 36 including the decoding and demultiplexing unit 15 and the viewpoint image generation unit 18 according to Embodiment 2, the target viewpoint configuration unit 17 according to Embodiment 2, and a viewpoint image selection unit 37.

The viewpoint image selection unit 37 selects any of the multiple viewpoint images input from each extended 360 video data reproducing unit, based on the target viewpoint position configured by the target viewpoint configuration unit 17, and generates the final target viewpoint image data. The viewpoint image selection unit 37 may control the decoding and demultiplexing unit 15 to compare the intermediate viewpoint definition with the target viewpoint and then decode only the intermediate 360 video set needed to generate the final target viewpoint image data.

### Intermediate 360 Video Set Generation Method and Target Viewpoint Image Generation Method

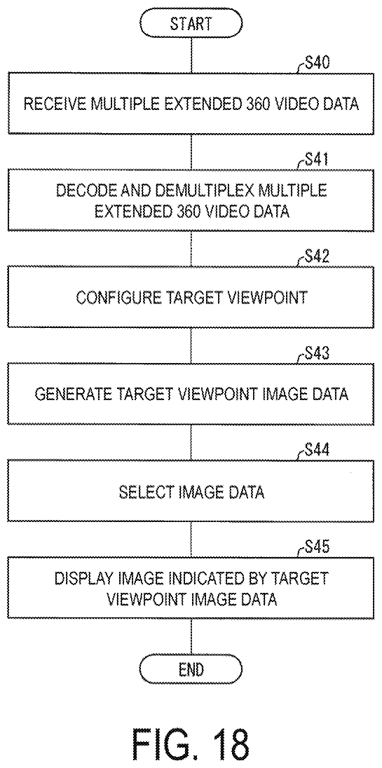

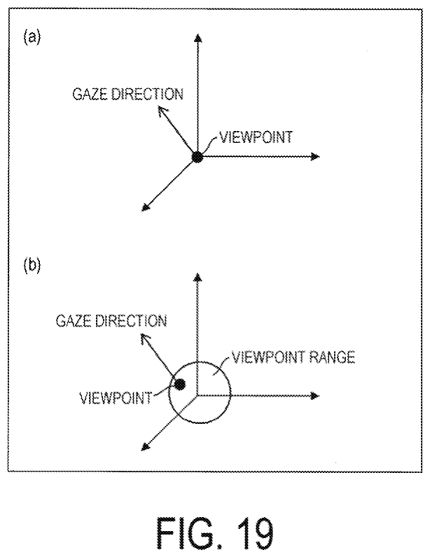

The target viewpoint image generation method by the extended 360 video data reproducing device 31 according to the present embodiment will be described in detail with reference to FIG. 18. FIG. 18 is a flowchart illustrating an example of the target viewpoint image generation method by the extended 360 video data reproducing device 31 according to the present embodiment. Note that detailed descriptions of the same steps as the intermediate 360 video set generation method or the target viewpoint image generation method according to Embodiment 1 are omitted.

### Target Viewpoint Image Generation Method

Each step of the target viewpoint image generation method according to the present embodiment will be described below with reference to FIG. 16.

First, the receiver 12 receives the extended 360 video data transmitted by the communication unit 7 of the extended 360 video data recording device 32 and the extended 360 video data transmitted by the communication unit 7 of the extended 360 video data recording device 33 (step S40).

Each decoding and demultiplexing unit 15 of the extended 360 video data reproducing unit 35 and each decoding and demultiplexing unit 15 of the extended 360 video data reproducing unit 36 respectively decodes the extended 360 video data received by the receiver 12, demultiplexes the decoded data, and thereby generates an intermediate 360 video set and intermediate viewpoint definition information, reads the generated intermediate viewpoint definition information and configures intermediate viewpoint definition (step S41).

The target viewpoint configuration unit 17 configures a target viewpoint (step S42).

With reference to the intermediate 360 video set demultiplexed by the decoding and demultiplexing unit 15, and the intermediate viewpoint definition configured by the decoding and demultiplexing unit 15, the viewpoint image generation unit 18 of the extended 360 video data reproducing unit 35 and the viewpoint image generation unit 18 of the extended 360 video data reproducing unit 36 generates target viewpoint image data indicating an image from the target viewpoint configured by the target viewpoint configuration unit 17 (step S43).

The viewpoint image selection unit 37 selects any one or more of the target viewpoint image data generated by the viewpoint image generation unit 18 of the extended 360 video data reproducing unit 35 and the viewpoint image generation unit 18 of the extended 360 video data reproducing unit 36, based on the target viewpoint position configured by the target viewpoint configuration unit 17, and generates the final target viewpoint image data (step S44).

The display unit 14 displays the image indicated by the target viewpoint image data selected or generated by the viewpoint image selection unit 37 (step S44).

Note that some methods are considered for selecting the final target viewpoint image in the viewpoint image selection unit 37, and thus examples are listed below.

### Example 1 of Target Viewpoint Image Selection

The viewpoint image selection unit 37 can be configured to select the target viewpoint image data obtained through synthesis from the intermediate viewpoint near the target viewpoint. That is, the viewpoint image selection unit 37 compares each intermediate viewpoint definition information with the target viewpoint, and selects a viewpoint image corresponding to the intermediate viewpoint definition information indicating to include the intermediate viewpoint that is closer to the target viewpoint.

For example, assume that in one intermediate 360 video set (intermediate 360 video set A), lattice points on a plane such that the horizontal component and the vertical component are vectors representing the lattice direction are data corresponding to the intermediate viewpoints, and in the other 360 video set (intermediate 360 video set B), points on the horizontal line segments, included in the wider horizontal range is data corresponding to the intermediate viewpoints.

In a case that the horizontal position of the target viewpoint is within the horizontal position range of the intermediate viewpoints included in the intermediate 360 video set A, the viewpoint image selection unit 37 selects the viewpoint image obtained through synthesis by using the intermediate 360 video set A. Otherwise, the viewpoint image obtained through synthesis by using the intermediate video set B is selected. With such a selection method of a viewpoint image, a target viewpoint image utilizing an intermediate viewpoint closer to a position of the target viewpoint can be obtained through synthesis within a specific range while reducing the number of entire intermediate viewpoints.

### Example 2 of Target Viewpoint Image Selection

In a case that particular intermediate viewpoint definition information indicates to include the intermediate viewpoints arranged at lattice points that is narrower in spacing in the vicinity of the target viewpoint, a viewpoint image corresponding to the intermediate viewpoint definition information is selected.

For example, assume that one intermediate 360 video set (intermediate 360 video set C) is data corresponding to intermediate viewpoints which are lattice points with a narrow spacing and are arranged in a relatively narrow spatial range, and the other intermediate 360 video set (intermediate 360 video set D) is data corresponding to intermediate viewpoints which are lattice points with a wide spacing and are arranged in a relatively wide spatial range.

The viewpoint image selection unit 37 selects a viewpoint image obtained through synthesis by using the intermediate 360 video set C in a case that there is a target viewpoint within a range of the intermediate viewpoints corresponding to the intermediate 360 video set C, and otherwise selects a viewpoint image obtained through synthesis by using the intermediate 360 video set D. Thus, in a case that the depth variation is large in a particular range of the imaging target scene, compared with a case of utilizing the intermediate 360 video set of intermediate viewpoints with a narrow spacing for the all target viewpoint positions, the intermediate 360 video set of intermediate viewpoints with a narrower spacing are utilized only in a particular range, and the intermediate 360 video set of intermediate viewpoints with a wider spacing are utilized for the rest of the range. Thus, the total number of intermediate viewpoints can be suppressed to mitigate the processing of generating the target viewpoint image data (data transmission reduction).

The differences between the target viewpoint image generation method according to the present embodiment described above and the target viewpoint image generation method according to Embodiment 1 will be described. First, the method according to the present embodiment differs from the method according to Embodiment 1 in that data representing the same scene by two or more different types of intermediate viewpoint sets are combined to obtain the final viewpoint image through synthesis. Accordingly, by appropriately selecting the intermediate viewpoints, the target viewpoint image data with the desired image quality or data amount can be generated.

### Summary of Embodiment 3

As described above, the extended 360 video data reproducing device 31 according to the present embodiment (the image data generation device in the claims) acquires multiple sets of intermediate viewpoint image data, each of which differs in the intermediate viewpoint definition, selects and refers to one or more intermediate viewpoint image data from among the multiple sets, and generates the target viewpoint image data. Accordingly, by appropriately selecting the intermediate viewpoints, the target viewpoint image data with the desired image quality or data amount can be generated.

### Modification Example 1: Reproduction of Multiple Viewpoint Images

In each of the above-described embodiments, the extended 360 video data reproducing device that outputs one viewpoint image corresponding to a single target viewpoint is described. The extended 360 video data reproducing device can be configured to configure multiple target viewpoints and output multiple viewpoint images corresponding to respective target viewpoints. For example, in this configuration, a stereoscopic view can be achieved by configuration two target viewpoint positions for the left and right eyes, and outputting and reproducing respective viewpoint images for the left eye and the right eye to the HMD.

### Modified Example 2: Intermediate Viewpoint Definition Information for Stereo Display

The extended 360 video data recording and reproducing system may be configured to use left eye extended 360 video data and right eye extended 360 video data for stereo display. In that case, it is preferred to be configured to refer to intermediate viewpoint definition information on one eye (e.g., left eye) to determine an intermediate viewpoint of the other eye (e.g., right eye). Specifically, lattice points on a predetermined plane are configured as intermediate viewpoints of the left eye, and a position displaced by a predetermined distance from the intermediate viewpoints of the left eye (for example, the typical distance between the left eye and the right eye) in the horizontal direction is configured as intermediate viewpoints of the right eye. This allows for a reduction in the amount of data of intermediate viewpoint definition information for specifying the intermediate viewpoints of the right eye, while facilitating the derivation of the intermediate viewpoints of the right eye in situations where a specific left eye intermediate viewpoint is given.

### Implementation Examples by Software

The control blocks (particularly the processing units 8, 13, 22, and 34) of the video data recording devices 3, 32, and 33, and the video data reproducing devices 4, 21, and 31 may be achieved with a logic circuit (hardware) formed as an integrated circuit (IC chip) or the like, or with software using a Central Processing Unit (CPU).

In the latter case, the video data recording devices 3, 32, and 33, and the video data reproducing devices 4, 21, and 31 include a CPU performing instructions of a program that is software implementing the functions, a Read Only Memory (ROM) or a storage device (these are referred to as recording media) in which the program and various data are stored to be readable by a computer (or CPU), a Random Access Memory (RAM) in which the program is deployed, and the like. The computer (or CPU) reads from the recording medium and performs the program to achieve the object of the present invention. As the above-described recording medium, a “non-transitory tangible medium” such as a tape, a disk, a card, a semiconductor memory, and a programmable logic circuit can be used. The above-described program may be supplied to the above-described computer via an arbitrary transmission medium (such as a communication network and a broadcast wave) capable of transmitting the program, Note that one aspect of the present invention may also be implemented in a form of a data signal embedded in a carrier wave in which the program is embodied by electronic transmission.

### Supplement

An image data generation device (extended 360 video data recording device 3, 32, 33) according to a first aspect of the present invention is an image data generation device for generating image data, the image data generation device including: an input image data acquisition unit (communication unit 7) configured to acquire multiple input image data for representing images from multiple viewpoints different from each other; and an intermediate viewpoint image data generation unit (intermediate 360 video set generation unit 10) configured to refer to at least one of the multiple input image data and generate intermediate viewpoint image data for indicating images corresponding to the viewpoints included in multiple intermediate viewpoints regularly arranged in at least one dimension direction for a straight line or curved line coordinate system of one or more dimensions.

According to the above-described configuration, in the image data generation device that generates the target viewpoint image data with reference to the intermediate viewpoint image data, the target viewpoint image can be generated based on the multiple intermediate viewpoints regularly arranged, and thus the generation and reproducing of the target viewpoint image can be simplified compared to a case that the viewpoint image is generated directly from the camera image.

In an image data generation device (extended 360 video data recording device 3, 32, 33) according to a second aspect of the present invention, in the above-described first aspect, distances between intermediate viewpoints adjacent in the at least one dimension direction among the multiple intermediate viewpoints may be equal to each other.

According to the above-described configuration, the intermediate viewpoint in the vicinity of the target viewpoint can be easily identified.

In an image data generation device (extended 360 video data recording device 3, 32, 33) according to a third aspect of the present invention, in the above-described first or second aspect, the multiple intermediate viewpoints may be arranged regularly in two-dimensional directions for a straight line or curved line coordinate system of two or more dimensions.

According to the above-described configuration, the intermediate viewpoint in the vicinity of the target viewpoint can be further easily identified.

In an image data generation device (extended 360 video data recording device 3, 32, 33) according to a fourth aspect of the present invention, in the above-described first or second aspect, the multiple intermediate viewpoints may be arranged regularly in three-dimensional directions for a straight line or curved line coordinate system of three or more dimensions.

According to the above-described configuration, the intermediate viewpoint in the vicinity of the target viewpoint can be further easily identified.

In an image data generation device (extended 360 video data recording device 3, 32, 33) according to a fifth aspect of the present invention, in the above-described first to fourth aspects, an arrangement of the multiple intermediate viewpoints may be limited within a predetermined range for the straight line or curved line coordinate system of one or more dimensions.

According to the above-described configuration, image information that is not utilized for the target viewpoint synthesis can be reduced.

In an image data generation device (extended 360 video data recording device 3, 32, 33) according to a sixth aspect of the present invention, in the above-described fifth aspect, in a case that the predetermined range is wider in a particular direction relative to other directions, the multiple intermediate viewpoints may be arranged on a straight line or on a plane along the particular direction.

According to the above-described configuration, the intermediate viewpoints required for the target viewpoint synthesis are appropriately arranged within a predetermined range.

In an image data generation device (extended 360 video data recording device 3, 32, 33) according to a seventh aspect of the present invention, in the above-described first to fifth aspects, the intermediate viewpoint image data generation unit may refer to an index for indicating a magnitude of a spatial variation in depth of each imaging target indicated by the multiple input image data, and configure a distance between intermediate viewpoints adjacent in the at least one dimension direction among the multiple intermediate viewpoints to be narrower as the magnitude of the spatial variation is larger.

According to the above-described configuration, in a case that the magnitude of spatial variation in the depth of the imaging target is small, the data amount of intermediate viewpoint image data can be reduced by reducing the number of intermediate viewpoints required.

In an image data generation device (extended 360 video data recording device 3, 32, 33) according to an eighth aspect of the present invention, in the above-described first to seventh aspects, the intermediate viewpoint image data generation unit may refer to at least one of the multiple input image data, and generate the intermediate viewpoint image data, based on each position of a camera that has captured an image of the images, a parameter of the camera, each position of the multiple intermediate viewpoints, and scene model information related to each imaging target of the image.

According to the above-described configuration, the intermediate viewpoint image data based on the actual imaging target can be generated.

In an image data generation device (extended 360 video data recording device 3, 32, 33) according to a ninth aspect of the present invention, in the above-described first to eighth aspects, the intermediate viewpoint image data generation unit may, preferentially refer to an input image datum of the multiple input image data representing an image captured by a camera having an optical axis closest to a direction from a target intermediate viewpoint to an imaging target, and generate the intermediate viewpoint image data indicating an image of the imaging target with the target intermediate viewpoint as a viewpoint.

According to the above-described configuration, the intermediate viewpoint image data can be generated based on the input image data closest to the actual imaging target.

In an image data generation device (extended 360 video data recording device 3, 32, 33) according to a 10th aspect of the present invention, in the above-described first to ninth aspects, a multiplexing unit configured to multiplex respective intermediate viewpoint image data generated by the intermediate viewpoint image data generation unit may be provided.

According to the above-described configuration, the multiple intermediate viewpoint data can be transmitted collectively.

In an image data generation device (extended 360 video data recording device 3, 32, 33) according to an 11th aspect of the present invention, in the above-described 10th aspect, the multiplexing unit may multiplex the respective intermediate viewpoint image data that the intermediate viewpoint image data generation unit generates by applying a common mapping.

According to the above-described configuration, only the image to which the common mapping has been applied is processed, so the target viewpoint synthesis process can be simplified.

In an image data generation device (extended 360 video data recording device 3, 32, 33) according to a 12th aspect of the present invention, in the above-described 10th or 11th aspect, the multiplexing unit may multiplex the respective intermediate viewpoint image data for indicating images with intermediate viewpoints having a same reference direction, as viewpoints.

According to the above-described configuration, only the images corresponding to the viewpoints, the intermediate viewpoints having the same reference direction is needed to be processed, so the target viewpoint synthesis process can be simplified.

In an image data generation device (extended 360 video data recording device 3, 32, 33) according to a 13th aspect of the present invention, in the above-described 10th to 12th aspect, the multiplexing unit may multiplex the respective intermediate viewpoint image data and map data associating the respective intermediate viewpoint image data with the multiple intermediate viewpoints.

According to the above-described configuration, the image corresponding to an arbitrary intermediate viewpoint can easily be identified, and thus the target viewpoint synthesis process can be simplified.

In an image data generation device (extended 360 video data recording device 3, 32, 33) according to a 14th aspect of the present invention, in the above-described 10th to 13th aspect, the multiplexing unit may multiplex the respective intermediate viewpoint image data and information for indicating that the multiple intermediate viewpoints are arranged limitedly within a predetermined range for a straight line or curved line coordinate system of one or more dimensions.

According to the above configuration, the range can be configured without analyzing the position of the intermediate viewpoint.

In an image data generation device (extended 360 video data recording device 3, 32, 33) according to a 15th aspect of the present invention, in the above-described 10th to 14th aspect, the multiplexing unit may multiplex the respective intermediate viewpoint image data and information related to definition of the multiple intermediate viewpoints.

According to the above-described configuration, in a case that reference is made to the intermediate viewpoint image data to generate the target viewpoint image data, appropriate intermediate viewpoints can be configured according to the structure or breadth of the target scene with reference to the intermediate viewpoint definition information.

An image data generation device (extended 360 video data reproducing device 4, 21, 31) according to a 16th aspect of the present invention is an image data generation device for generating image data for indicating an image from a target viewpoint, the image data generation device including: an intermediate viewpoint image data acquisition unit (receiver 12) configured to acquire intermediate viewpoint image data for indicating images corresponding to the viewpoints included in multiple intermediate viewpoints regularly arranged in at least one dimension direction for a straight line or curved line coordinate system of one or more dimensions; and a target viewpoint image data generation unit (viewpoint image generation unit 18) configured to referring to the intermediate viewpoint image data acquired by the intermediate viewpoint image data acquisition unit, and generate target viewpoint image data for indicating the image from the target viewpoint.

According to the above-described configuration, the target viewpoint image can be generated based on the multiple intermediate viewpoints regularly arranged, and thus the generation and reproducing of the target viewpoint image can be simplified compared to a case that the viewpoint image is generated directly from the camera image.

In an image data generation device (extended 360 video data reproducing device 4, 21, 31) according to a 17th aspect of the present invention, in the above-described 16th aspect, the target viewpoint image data generation unit may refer to the intermediate viewpoint image data indicating the image corresponding to viewpoints, one or two points of intermediate viewpoints at a position closest to a position of the target viewpoint, and generate the target viewpoint image data for indicating the image from the target viewpoint.

According to the above-described configuration, the image can be generated with, as a viewpoint, a target viewpoint that is more approximated to the actual viewpoint.

In an image data generation device (extended 360 video data reproducing device 31) according to an 18th aspect of the present invention, in the above-described 16th or 17th aspect, the intermediate viewpoint image data acquisition unit may acquire multiple sets of the intermediate viewpoint image data, each differing in intermediate viewpoint definitions, and the target viewpoint image data generation unit may select at least one of a plurality of the target viewpoint images generated from the multiple sets acquired by the intermediate viewpoint image data acquisition unit and generate the target viewpoint image data.

According to the above-described configuration, the target viewpoint image data with the desired image quality or processing load can be generated by appropriately selecting the intermediate viewpoints.

An image reproducing device (extended 360 video data reproducing device 31) according to a 19th aspect of the present invention includes the image data generation device according to any one of the 16th to 18th aspects, and a display unit configured to display an image indicated by the target viewpoint image data generated by the target viewpoint image data generation unit.

According to the above-described configuration, the image data indicated by the target viewpoint image data can be displayed.

An image data generation method according to a 20th aspect of the present invention is an image data generation method by an image data generation device for generating image data, the image data generation method including the steps of: acquiring multiple input image data representing images from multiple viewpoints different from each other; and referring to at least one of the multiple input image data and generating intermediate viewpoint image data for indicating images corresponding to the viewpoints included in multiple intermediate viewpoints regularly arranged in at least one dimension direction for a straight line or curved line coordinate system of one or more dimensions.

According to the above-described configuration, the same effect as that of the first aspect can be achieved.

An image data generation method according to a 21st aspect of the present invention is an image data generation method by an image data generation device for generating image data for indicating an image from a target viewpoint, the image data generation method including the steps of: acquiring intermediate viewpoint image data for indicating images corresponding to the viewpoints included in multiple intermediate viewpoints regularly arranged in at least one dimension direction for a straight line or curved line coordinate system of one or more dimensions; and referring to the intermediate viewpoint image data acquired in the step of acquiring intermediate viewpoint image data acquiring step and generating target viewpoint image data for indicating an image from the target viewpoint.

According to the above-described configuration, the same effect as that of the 16th aspect can be achieved.

The image data generation device according to each of the aspects of the present invention may be implemented by a computer. In this case, a control program of the image data generation device configured to cause a computer to operate as each unit (software component) included in the image data generation device to implement the image data generation device by the computer and a computer-readable recording medium configured to record the control program are also included in the scope of the present invention.

The present invention is not limited to each of the above-described embodiments. It is possible to make various modifications within the scope of the claims. An embodiment obtained by appropriately combining technical elements each disclosed in different embodiments falls also within the technical scope of the present invention. Further, a new technical feature can be formed by combining technical elements disclosed in the respective embodiments.

### CROSS-REFERENCE OF RELATED APPLICATION

This application claims the benefit of priority to JP 2017-075361 filed on Apr. 5, 2017, which is incorporated herein by reference in its entirety.

### REFERENCE SIGNS LIST

1, 30 Extended 360 video data recording and reproducing system
2 Imaging apparatus
3, 32, 33 Extended 360 video data recording device
4, 21, 31 Extended 360 video data reproducing device
5 Imaging unit
6 Transmitter
7 Communication unit
8, 13, 22, 34 Processing unit
9, 16 Intermediate viewpoint configuration unit
10 Intermediate 360 video set generation unit
11 Coding and multiplexing unit
12 Receiver
14 Display unit
15 Decoding and demultiplexing unit
17 Target viewpoint configuration unit
18 Viewpoint image generation unit
35, 36 Extended 360 video data reproducing unit
37 Viewpoint image selection unit

1. An image data generation device for generating image data, the image data generation device comprising:
an input image data acquisition circuitry that acquires multiple input image data corresponding to multiple viewpoints different from each other; and
an intermediate viewpoint image data generation circuitry that generates intermediate viewpoint image data indicating images corresponding to the viewpoints included in multiple intermediate viewpoints arranged in at least one dimension direction for a straight line or curved line coordinate system of one or more dimensions.

2. The image data generation device according to claim 1, wherein
distances between intermediate viewpoints adjacent in the at least one dimension direction among the multiple intermediate viewpoints are equal to each other.

3. The image data generation device according to claim 1, wherein
the multiple intermediate viewpoints are arranged regularly in two-dimensional directions for a straight line or curved line coordinate system of two or more dimensions.

4. The image data generation device according to claim 1, wherein
the multiple intermediate viewpoints are arranged regularly in three-dimensional directions for a straight line or curved line coordinate system of three or more dimensions.

5. The image data generation device according to claim 1, wherein an arrangement of the multiple intermediate viewpoints is limited within a predetermined range for the straight line or curved line coordinate system of one or more dimensions.

6. The image data generation device according to claim 5, wherein
in a case that the predetermined range is wider in a particular direction relative to other directions, the multiple intermediate viewpoints are arranged on a straight line or on a plane along the particular direction.

7. (canceled)

8. The image data generation device according to claim 1, wherein
the intermediate viewpoint image data generation circuitry generates the intermediate viewpoint image data, based on (i) each position of a camera that has captured an image of the images, (ii) a parameter of the camera, (iii) each position of the multiple intermediate viewpoints, and (iv) scene model information related to each imaging target of the image.

9. The image data generation device according to claim 1, wherein
the intermediate viewpoint image data generation circuitry generates the intermediate viewpoint image data for indicating an image of the imaging target with the target intermediate viewpoint as a viewpoint by preferentially referring to an input image datum of the multiple input image data representing an image captured by a camera having an optical axis closest to a direction from a target intermediate viewpoint to an imaging target.

10. The image data generation device according to claim 1, further comprising:
a multiplexing circuitry that multiplexes respective intermediate viewpoint image data.

11. The image data generation device according to claim 10, wherein
the multiplexing circuitry multiplexes the respective intermediate viewpoint image data generated by applying a common mapping.

12. The image data generation device according to claim 10, wherein
the multiplexing circuitry multiplexes the respective intermediate viewpoint image data for indicating images corresponding to the viewpoints included in intermediate viewpoints having a same reference direction.

13. The image data generation device according to claim 10, wherein
the multiplexing circuitry multiplexes the respective intermediate viewpoint image data and map data associating the respective intermediate viewpoint image data with the multiple intermediate viewpoints.

14. The image data generation device according to claim 10, wherein
the multiplexing circuitry multiplexes the respective intermediate viewpoint image data and information for indicating that the multiple intermediate viewpoints are arranged limitedly within a predetermined range in the straight line or curved line coordinate system of one or more dimensions.

15. The image data generation device according to claim 10, wherein
the multiplexing circuitry multiplexes the respective intermediate viewpoint image data and information related to definition of the multiple intermediate viewpoints.

16. An image data generation device for generating image data for indicating an image from a target viewpoint, the image data generation device comprising:
an intermediate viewpoint image data acquisition circuitry that acquires intermediate viewpoint image data for indicating images corresponding to the viewpoints included in multiple intermediate viewpoints regularly arranged in at least one dimension direction in a straight line or curved line coordinate system of one or more dimensions; and
a target viewpoint image data generation circuitry that generates target viewpoint image data for indicating the image from the target viewpoint by referring to the intermediate viewpoint image data.

17-19. (canceled)

20. An image data generation method by an image data generation device for generating image data, the image data generation method comprising:
acquiring multiple input image data representing images from multiple viewpoints different from each other; and
generating intermediate viewpoint image data for indicating images corresponding to the viewpoints included in multiple intermediate viewpoints regularly arranged in at least one dimension direction in a straight line or curved line coordinate system of one or more dimensions by referring to at least one of the multiple input image data.

21-25. (canceled)
